(19) United States
(12) Patent Application Publication
(10) Pub. No.: US 2026/0268024 A1
(43) Pub. Date: Sep. 10, 2026

(54) METHODS AND SYSTEMS FOR IMPLEMENTING SECURE AND TRUSTWORTHY ARTIFICIAL INTELLIGENCE

(71) Applicant: PureCipher Inc., Boca Raton, FL (US)

(72) Inventors: William Edward Hahn, Delray Beach, FL (US); Wendy Chin, New York, NY (US); Graham Andrew Morehead, Spokane, WA (US); Brandon Wade Langenberg, Boca Raton, FL (US); Matthew Oliver Ikle, Alamosa, CO (US); Mykyta Storozhenko, Boca Raton, FL (US); Prajwal Nagaraj, Delray Beach, FL (US)

(21) Appl. No.: 19/166,152

(22) PCT Filed: Aug. 15, 2024
(86) PCT No.: PCT/US2024/042500

§ 371 Date: Sep. 17, 2025

Related U.S. Application Data
(60) Provisional application No. 63/520,803, filed on Aug. 21, 2023.
(60) Provisional application No. 63/644,173, filed on May 8, 2024.

(51) Int. Cl. G06F 21/64; G06F 21/16; H04L 9/00; H04L 9/08; H04L 9/32

(52) U.S. Cl. CPC G06F 21/64; G06F 21/16; H04L 9/0869; H04L 9/3236; H04L 9/3247; H04L 9/50; H04L 2209/608

(57) ABSTRACT

Provided herein are systems, methods, computer-readable media, and techniques for providing trusted artificial intelligence (AI) using Fully Homomorphic Encryption (FHE), comprising: (A) providing a deep neural network (DNN)-based model with modified architecture, wherein the modified architecture at least (i) uses a Gaussian function as an activation function and (ii) removes one or more pooling layers; (B) obtaining encrypted data, wherein the encrypted data are generated by applying the FHE to plaintext data; and (C) generating an inference with the DNN-based model based on the encrypted data. Further provided herein are systems, methods, computer-readable media, and techniques for providing trusted AI using stochastic computing, using noise based computing, using an artificial immune system, and with secure multi-party computation (SMPC) based at least in part on watermarking.

### CROSS-REFERENCE

This application claims priority to U.S. Provisional Application No. 63/520,803, filed Aug. 21, 2023, and U.S. Provisional Application No. 63/644,173, filed May 8, 2024, which applications are incorporated herein by reference in the entirety.

### BACKGROUND

It is expected by 2025, that 96% of global supply chain and manufacturing business will already be utilizing, or at least plotting use cases for, artificial intelligence (AI). The rapid expansion of AI into new industries with new stakeholders, coupled with an evolving threat landscape and huge growth in AI, presents certain security risks. Bad actors may exploit both the strengths and vulnerabilities of AI to directly and indirectly create new attacks and worsen existing security measures. The world of Identity and Access Management is equally affected by these trends in AI. For example, the industry is rapidly embracing AI for authentication, identity management, and secure access control. In some cases, behavioral patterns that are driven by AI and machine learning (ML) are being increasingly used to both grant access (e.g., password-less access) as well as deny access or detect breaches. Other techniques such as behavior-based adaptive access controls also depend on AI and ML algorithms.

### SUMMARY

The present disclosure addresses the above issues by providing a trusted artificial intelligence (AI). An aspect of the present disclosure includes a method for providing trusted artificial intelligence (AI) using Fully Homomorphic Encryption (FHE). The method comprises: (a) providing a deep neural network (DNN)-based model with modified architecture, where the modified architecture at least (i) uses a Gaussian function as an activation function and (ii) removes one or more pooling layers; (b) obtaining encrypted data, where the encrypted data are generated by applying the FHE to plaintext data; and (c) generating an inference with the DNN-based model based on the encrypted data.

In some embodiments, the DNN-based model is trained on plaintext training data. In some embodiments, the DNN-based model is trained on encrypted training data. In some embodiments, the DNN-based model is pre-trained on plaintext training data and encrypted training data. In some embodiments, the method further comprises during a training phase to train the DNN-based model with the modified architecture, selecting values for one or more hyperparameters based at least in part on monitoring criticality. In some embodiments, the method further comprises identifying and testing FHE-appropriate approximations and alternatives for various nonlinear activation and loss functions. In some embodiments, the one or more hyperparameters comprise at least one of mean and variance of the random initialization distributions, batch size, learning rate, or optimizer settings. In some embodiments, a mean or variance of the Gaussian function is tuned during the training phase. In some embodiments, the encrypted data are generated using a homomorphic encryption scheme such that computation results generated on the encrypted data match computation results generated on the plaintext data. In some embodiments, the homomorphic encryption scheme comprises CKKS algorithm or TFHE algorithm. In some embodiments, the DNN-based model is trained using adversarial machine learning techniques. In some embodiments, the adversarial machine learning techniques comprise proactively acquiring knowledge from machine learning systems under attack. In some embodiments, training the DNN-based model further comprises adopting reinforcement learning and transfer learning. In some embodiments, the DNN-based model is trained to automatically monitor a cyberthreat or a cyberattack. In some embodiments, the cyberthreat comprises one or more of data poison attacks, malicious AIs, or malwares. In some embodiments, the DNN-based model is trained to detect an anomaly. In some embodiments, the DNN-based model is trained using collaborative learning. In some embodiments, the DNN-based model is trained by a plurality of computing nodes, wherein each computing node trains the DNN-based model using a set of training data not shared with other computing nodes. In some embodiments, the inference comprises an anomaly detection output generated by a computing node. In some embodiments, the method further comprises aggregating a plurality of anomaly detection outputs from a plurality of computing nodes to generate an anomaly detection result. In some embodiments, each of the plurality of computing nodes generates an anomaly detection output based at least in part on a portion of distributed data. In some embodiments, the portion of distributed data comprise FHE-encrypted data. In some embodiments, the plurality of anomaly detection outputs are shared and stored using blockchain. In some embodiments, the plaintext data comprises image data. In some embodiments, the method further comprises generating a hypervector based on the plaintext data to accelerate the computation. In some embodiments, the plaintext data is embedded with machine-readable data using one or more encoding algorithms. In some embodiments, the machine-readable data is embedded at different hierarchical levels. In some embodiments, the different hierarchical levels comprise character-level, word-level, and sentence-level of a textual input data. In some embodiments, the machine-readable data comprises Universal Multiplex Watermarks used for document authentication and verification. In some embodiments, the Universal Multiplex Watermark contain metadata and encrypted identifying information of a data source or an owner of the plaintext data. In some embodiments, the Universal Multiplex Watermarks are undetectable to a human, and wherein the Universal Multiplex Watermarks are detectable and decodable by hardware or software. In some embodiments, the Universal Multiplex Watermarks are used for confirming the authenticity of the plaintext data and verifying a source and integrity of the plaintext data. In some embodiments, the FHE is applied to plaintext data after embedding the plaintext data with Universal Multiplex Watermarks. In some embodiments, the method further comprises decrypting the encrypted data and verifying an integrity of the decrypted data using a checksum. In some embodiments, the checksum is derived from the plaintext data prior to encryption and is stored on a blockchain for secure and tamper-resistant record keeping. In some embodiments, the checksums on the blockchain are used for investigation of unauthorized data alteration attempts. In some embodiments, the unauthorized data alteration attempts are detected by detecting a mismatch between the decrypted data and the recorded checksum. In some embodiments, the method further comprises generating an alert upon detection of the mismatch. In some embodiments, the alert automatically triggers an automatic mitigation process, including at least one of isolation of affected data, initiation of a security audit, or activation of data recovery measures from a verified backup. In some embodiments, the embedded machine-readable data represents a watermark functioning as a unique identifier for the plaintext data. In some embodiments, the unique identifier is encrypted using the FHE, enabling computations to be performed on the encrypted watermark without revealing content of the unique identifier. In some embodiments, the encrypted watermark is verified by applying one or more operations of the FHE that correspond to watermark verification, yielding an encrypted verification result. In some embodiments, the encrypted verification result is decrypted to (i) verify an authenticity of the plaintext data, and (ii) determine whether the plaintext data has been tampered with or replaced. In some embodiments, the unique watermark identifier is linked to a transaction on a blockchain, and wherein an immutable record of the unique watermark identifier, ownership of the plaintext data, and one or more associated transactions is recorded on the blockchain. In some embodiments, the one or more associated transactions are used as a verification point for the unique watermark identifier, which serves as a checksum for the plaintext data. In some embodiments, embedding the machine-readable data and encrypting the plaintext data are applied on multiple layers of data representation. In some embodiments, the multiple layers of data representation comprise a pixel level for images, frame level for videos, and packet level for network communications. In some embodiments, embedding the machine-readable data and encrypting the plaintext data employ one or more machine learning algorithms.

In another aspect, a method provides trusted AI using stochastic computing, comprising: (a) receiving an original image at a software application running on an endpoint computing device; (b) generating, by the software application, a plurality of image segments by chopping up the original image into a plurality of random bits; (c) generating inferences on the plurality of image segments using a pre-trained deep neural network (DNN)-based model in a cloud; (d) providing the inferences to the software application on the endpoint computing device; and (e) aggregating the inferences, by the software application, to determine an outcome. In some embodiments, an accuracy of the outcome is similar to that of an outcome obtained by generating an inference directly on the original image. In some embodiments, the inferences comprise a plurality of labels predicted for the plurality of image segments.

In another aspect, a method provides trusted AI using noise-based computing (NBC), comprising: (a) receiving an original image at a software application running on an endpoint computing device; (b) generating, by the software application, a plurality of random images; (c) processing, using a pre-trained deep neural network (DNN)-based model in a cloud, the plurality of random images to predict a plurality of labeled images for the plurality of random images; (d) selecting, by the software application, a subset of the plurality of labeled images, wherein a number of images in the subset of the plurality of labeled images is set by the software application; and (e) generating, using weighted average and probability, a prediction output based at last in part on the subset of the plurality of labeled images. In some embodiments, the plurality of random images are generated by a random image generator of the software application.

In another aspect, a method provides trusted AI using an artificial immune system, comprising: (a) obtaining a set of detectors that are diverse and capable of identifying non-self elements, where the set of detectors represent a deep neural network (DNN)-based model; (b) providing an encrypted dataset to the set of detectors, wherein the encrypted dataset is generated by applying fully homomorphic encryption (FHE) to plaintext data; (c) executing the artificial immune system to identify non-self elements within the encrypted dataset that correspond to one or more of anomalies, intrusions, or attacks; (d) adapting the set of detectors via one or more machine learning techniques based at least in part on results of the executing of the artificial immune system, wherein the one or more machine learning techniques comprise one or more of reinforcement learning, evolutionary algorithms or swarm intelligence; (e) implementing feedback loops to continually refine and improve the detection capability of the artificial immune system.

In another aspect, a method provides trusted AI with secure multi-party computation (SMPC) based at least in part on watermarking, comprising: (a) applying a watermark to plaintext data, thereby generating watermarked plaintext data, wherein the watermark is generated using an SMPC protocol; (b) encrypting the plaintext data using a homomorphic encryption scheme, thereby generating encrypted watermarked plaintext data; (c) training a deep neural network (DNN)-based model using the encrypted watermarked plaintext data; (d) generating an inference with the DNN-based model based at least in part on the encrypted watermarked plaintext data in response to verifying integrity of the encrypted watermarked plaintext data; (e) storing a verification result on a blockchain, wherein the verification result is based at least in part on the verifying of the integrity of the encrypted watermarked plaintext data.

In another aspect, a trusted AI model implements the method of any of the preceding aspects to ensure an integrity and authenticity of data used in the training and operation of the trusted AI model.

Another aspect of the present disclosure provides an Application Programming Interface (API) for Universal Steganographic Watermarking. The API comprises: a conceal API configured to embed a secret data within a cover file and generate a sealed file; a reveal API configured to take the sealed file as input and extract the secret data; and a verify API configured to verify an integrity of the sealed file without extracting the secret data.

In some embodiments, the conceal API performs the operations comprising: scrambling the secret data using a private seed value to generate scrambled secret data, compressing the scrambled secret data into compressed secret data, hashing the compressed secret data to generate a cryptographic signature. In some embodiments, the cryptographic signature is embedded into the cover file at an offset. In some cases, the offset is determined based at least in part on a type of the cover file. In some instances, the type of the cover file is selected from the group consisting of a text file, an image file, a video file, an audio file, and a HTML file. In some embodiments, the cryptographic signature is used by the verify API for verifying the integrity of the sealed file. In some embodiments, the private seed value is accessible by authorized users. In some embodiments, the cryptographic signature is stored on a blockchain.

In some cases, the conceal API is further configured to, prior to scrambling the secret data, encode the cover file using an encoding scheme. For instance, the encoding scheme is selected based at least in part on a type of the cover file. In some cases, the conceal APIis further configured to, prior to scrambling the secret data, encode the secret data using an encoding scheme. In some instances, the conceal API is further configured to standardize the encoded secret data.

Another aspect of the present disclosure provides a non-transitory computer readable medium comprising machine executable code that, upon execution by one or more computer processors, implements any of the methods or techniques above or elsewhere herein.

Another aspect of the present disclosure provides a system comprising one or more computer processors and computer memory coupled thereto. The computer memory comprises machine executable code that, upon execution by the one or more computer processors, implements any of the methods or techniques above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example process for a user interacting with a trusted artificial intelligence (AI);

FIG. 2 shows an example architecture diagram for a Fully Homomorphic Encryption (FHE)-based trusted AI;

FIG. 3 shows an example application of the systems, the methods, the computer-readable media, and the techniques disclosed herein with respect to autonomous vehicles;

FIG. 4 shows an example application of the systems, the methods, the computer-readable media, and the techniques disclosed herein with respect to emails;

FIG. 5 shows an example process of implementing trusted AI using FHE;

FIG. 6A shows an example of a flowchart illustrating a method for providing trusted artificial intelligence (AI) using FHE;

FIG. 6B shows an example of a flowchart illustrating a method for providing trusted AI using stochastic computing;

FIG. 6C shows an example of a flowchart illustrating a method for providing trusted AI using noise based computing;

FIG. 6D shows an example of a flowchart illustrating a method for providing trusted AI using an artificial immune system;

FIG. 6E shows an example of a flowchart illustrating a method for providing trusted AI with secure multi-party computation (SMPC) based at least in part on watermarking;

FIG. 7 shows an example of a computer system that is programmed or otherwise configured to the methods disclosed herein.

FIG. 8 schematically shows an example of data integrity Application Programming Interface (API) implementing the methods herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

With artificial intelligence (AI) systems becoming more prevalent and integral to the digital world, ensuring their safety, privacy, and practicality is an important concern. One operational challenge posed by these transformational capabilities is that with today's technologies, many AI/ML models are trained, and perform inferences on unencrypted data. Accordingly, the entire ecosystem may be subject to the risk of false data injection, tampering, and intruder observation. An undiscovered breach in the heart of the AI-driven identity and access management system could have even greater catastrophic consequences as more systems operate in an unattended fashion to control access and identities. As AI/ML models are often trained on unencrypted data, changes to network design and hyperparameters provided by the systems, the methods, the computer-readable media, and the techniques disclosed herein have not been tried before as these changes may be, in some cases, suboptimal when applied to AI/ML models operating on unencrypted (plaintext) inputs.

For example, there can be critical negative impact when an autonomous vehicle's data is tampered, a cybersecurity behavioral monitoring program is injected with false data, or an identity management system's protections are compromised or leaked. Even in a Zero Trust environment, it is not sufficient to assume that adversaries will never penetrate perimeter defenses that surround an AI system that is being so heavily depended upon. The risk is amplified by the advent of quantum computing in the hands of adversaries.

The innovative application of an Artificial Immune System (AIS) to AI provided by the systems, the methods, the computer-readable media, and the techniques disclosed herein offers an advanced solution to this complex problem. By integrating concepts from immunology and cutting-edge technologies such as adversarial machine learning, blockchain, Fully Homomorphic Encryption (FHE), Secure Multi-Party Computation (SMPC), Stochastic Computing (SC), etc. the AIS provided herein creates a proactive, adaptable, and resilient defense mechanism that preserves data privacy.

FHE across the AI computational lifecycle can mitigate risks of this complex problem. FHE may have potential applications across many industries with sensitive or valuable data and can impact multiple critical technologies. By combining FHE with Deep Neural Network (DNN) technology, in concert with the steganography watermarking dataset technology, the systems, the methods, the computer-readable media, and the techniques disclosed herein may authenticate incoming and outgoing data from an AI model and ensure closed loop communication within the system using FHE. These innovations in leveraging emerging FHE and steganography watermarking technologies and creating new AI/ML architectures and approaches to train and perform inferences over the FHE data will create a quantum-safe capability built for a zero trust world. The DNN may, in some cases, be used defensively or offensively.

Through adversarial machine learning, the systems, the methods, the computer-readable media, and the techniques disclosed herein become capable of anticipating and defending against AI-targeted attacks. The blockchain component provides an immutable audit trail, decentralized security, and automated responses via smart contracts. Fully Homomorphic Encryption and Secure Multi-Party Computation ensure that privacy-preserving computations can be performed and data can be shared securely, even when multiple entities are involved. Lastly, the implementation of Stochastic Computing offers a robust and efficient computing approach that can resist adversarial manipulation and function effectively even in noisy, real-world environments.

The present disclosure provides a comprehensive AIS that can protect AI systems from a variety of threats, including AI attacks, hacks, privacy leaks, and deepfakes. The systems, the methods, the computer-readable media, and the techniques disclosed herein may provide safer, and secured AI-based applications, tools or platforms, and robust AI defense systems allowing them to be utilized to their full potential without compromising data security and user privacy.

The systems, the methods, the computer-readable media, and the techniques disclosed herein may further provide Secure AI to fight identity threats (SAIFIT) using advanced AI models based on Convolutional Neural Network (CNN) technology using Fully Homomorphically Encrypted data/images. Leveraging FHE technology and creating new AI/Machine Learning (ML) architectures and techniques to train and perform inferences over the FHE data will create a quantum-safe capability built for a zero trust world. Consistent with the desired outcomes, the SAIFIT provided herein may prevent or mitigate against novel identity and fraud risks, protect the exchange of anti-fraud and threat information, enhance personal data privacy, and enhance overall cyberspace security. This may address various key mission areas (e.g., of a government entity, of a company, etc.), such as, managing incidents, securing borders, preventing terrorism, securing aviation, and securing cyberspace. An additional benefit may be increased adoption of this capability, as users (e.g., company security, governmental security, etc.) may not have to replace existing systems. Instead, users may need to retrain similar AI models with SAIFIT capabilities. The end result may be a reduction in vulnerabilities for a wide array of threats. Furthermore, SAIFIT may be adaptable and expandable to other domains and use cases beyond identity, such as supply chain protection and other key areas.

Advantageously, the systems, the methods, the computer-readable media, and the techniques disclosed herein may provide quantum-safe encrypted and trusted AI models that may enable enterprises to perform analysis over encrypted data, thus eliminating a huge cyber-attack surface. In a real-world setting, such encrypted models may be used for secured and privacy preserving biometric identity verification, secured access and control for critical infrastructure and industries with sensitive information, by autonomous vehicles, etc.

### Certain Definitions

Unless otherwise defined, all technical terms used herein have the same meaning as commonly understood by one of ordinary skill in the art to which the present subject matter belongs.

As used in this specification and the appended claims, the terms “artificial intelligence,” “artificial intelligence techniques,” “artificial intelligence operation,” and “artificial intelligence algorithm” generally refer to any system or computational procedure that may take one or more actions to enhance or maximize a chance of achieving a goal. An example of such a goal is to mathematically or computationally model the probabilistic relationship between an exposure and an outcome like a CHC. The term “artificial intelligence” may include “generative modeling,” “deep learning” (DL), “machine learning”, or “reinforcement learning” (RL).

As used in this specification and the appended claims, the terms “machine learning,” “machine learning techniques,” “machine learning operation,” and “machine learning model” generally refer to any system or analytical or statistical procedure that may progressively improve computer performance of a task. An example of such a task is to mathematically or computationally model the probabilistic relationship between an exposure and an outcome like a CHC.

As used in this specification and the appended claims, “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

As used in this specification and the appended claims, when the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

As used in this specification and the appended claims, when the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used in this specification, “or” is intended to mean an “inclusive or” or what is also known as a “logical OR,” wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. As such, any reference to “or” herein is intended to encompass “and/or” unless otherwise stated.

As used in this specification and the appended claims, the indefinite articles “a” or “an,” and the corresponding associated definite articles “the” or “said,” are each intended to mean one or more unless otherwise stated, implied, or physically impossible. Yet further, it should be understood that the expressions “at least one of A and B, etc.,” “at least one of A or B, etc.,” “selected from A and B, etc.” and “selected from A or B, etc.” are each intended to mean either any recited element individually or any combination of two or more elements, for example, any of the elements from the group consisting of “A,” “B,” and “A AND B together,” etc.

As used in this specification and the appended claims “about” or “approximately” may mean within an acceptable error range for the value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where values are described in the application and claims, unless otherwise stated the term “about” meaning within an acceptable error range for the particular value may be assumed.

### Examples of Artificial Immune Systems (AIS)

As digital systems become more integrated into everyday life, maintaining their security and integrity has become more important. Secure integrated circuits may offer a hardware-based solution to safeguard sensitive information, employing several protective mechanisms that provide enhanced security against hardware and software attacks. The present disclosure provides Artificial Immune Systems with system security features, harnessing the power of machine learning and bio-inspired computing (inspired by the human body's natural defense mechanism).

The defense mechanism of the AIS may beneficially allow it to be able to defend a set of AI system-specific attacks. Artificial intelligence and machine learning systems may be targets with unique sets of vulnerabilities. Adversarial attacks, data privacy leaks, and AI hacks may be serious threats to AI-based systems and services. Attacks may compromise AI systems, leading to misclassifications or incorrect actions, while deepfakes and synthetic media pose significant challenges to trust and authenticity.

Turning first to adversarial attacks: AI systems may be subjected to adversarial attacks, where small, intentionally designed perturbations are added to data to deceive the AI system. For example, imperceptible changes to an image may cause a machine learning model to misclassify it. In a real-world scenario, this could mean, for example, misidentifying a stop sign as a speed limit sign, with potentially disastrous consequences in an autonomous driving context.

Turning next to data poisoning: in a training phase, ML algorithms may rely on large amounts of data. If this training data is tampered with or poisoned, the AI system can be trained to make incorrect decisions or predictions. Such poisoned data attacks can seriously impact the performance and reliability of AI applications.

Turning next to model inversion and membership inference attacks: these attacks may aim to retrieve sensitive information from AI models. In a model inversion attack, the attacker may use outputs from an ML model to infer details about the training data. A membership inference attack, on the other hand, may aim to determine whether a specific data point was part of a ML model's training set. Both types of attacks pose significant threats to privacy.

Turning next to deepfakes and synthetic media: the rapid advancement in generative AI techniques has resulted in the widespread proliferation of deepfakes (e.g., hyper-realistic artificial images, audio, video, etc.). These synthetic media may pose significant challenges to trust and authenticity in digital communications and may be used to spread misinformation, commit fraud, or engage in other malicious activities.

The systems, the methods, the computer-readable media, and the techniques disclosed herein present numerous advantages. Advantageously, the systems, the methods, the computer-readable media, and the techniques disclosed herein address challenges in defending AI/ML systems by developing a dynamic and adaptive technique capable of identifying and responding to these threats, in a manner akin to the biological immune system. More specifically, the systems, the methods, the computer-readable media, and the techniques disclosed herein may achieve this defense by implementing techniques including adversarial machine learning, blockchain, FHE, SMPC, or stochastic computing. Advantageously, the systems, the methods, the computer-readable media, and the techniques disclosed herein, similar to a biological immune system, can learn (e.g., via AIS implementing machine learning that identifies patterns in past attacks to predict and prepare for future threats) from previous attacks and responses, accordingly, thereby providing protection even with the rapidly changing nature of cyber threats. Further, by integrating the principles of immunology with AI, the systems, the methods, the computer-readable media, and the techniques disclosed herein, by implementing AIS, can offer a high degree of resilience and robustness, including handling multiple types of threats simultaneously, where, due to having a distributed architecture, even if one part of the architecture is compromised, other parts can continue to function and respond to the threat. Advantageously, the systems, the methods, the computer-readable media, and the techniques disclosed herein may provide an AIS that can operate autonomously, constantly monitoring for threats without the need for human intervention throughout identifying potential attacks, neutralizing potential attacks, or learning from potential attacks to improve future responses. Advantageously, the systems, the methods, the computer-readable media, and the techniques disclosed herein can provide protection while preserving the privacy of users' data. For example, using techniques like SMPC, and FHE to work with encrypted data, the systems, the methods, the computer-readable media, and the techniques disclosed herein may ensure that raw data remains confidential.

In a world where AI systems are ubiquitous and the threats against them are continually evolving, the AIS provided by the systems, the methods, the computer-readable media, and the techniques disclosed herein represents an important component of defense strategy. By developing an AIS for AI, the systems, the methods, the computer-readable media, and the techniques disclosed herein ensure that these technologies (e.g., AI/ML) can continue to provide their benefits without putting data security and privacy at risk.

In some embodiments, the AIS provided herein may employ one or more techniques including FHE, SMPC, blockchain, steganography and watermarking, etc.

### Examples of Machine Learning Techniques

As disclosed herein, in some cases, the systems, the methods, the computer-readable media, and the techniques disclosed herein may implement one or more machine learning techniques to create a robust, resilient AIS that protects AI systems. In some cases, machine learning may generally involve identifying and recognizing patterns in existing data in order to facilitate making predictions for subsequent data. ML may include a ML model (which may include, for example, a ML algorithm). Machine learning, whether analytical or statistical in nature, may provide deductive or abductive inference based on real or simulated data. The ML model may be a trained model. ML techniques may comprise one or more supervised, semi-supervised, self-supervised, or unsupervised ML techniques. For example, an ML model may be a trained model that is trained through supervised learning (e.g., various parameters are determined as weights or scaling factors). ML may comprise one or more of regression analysis, regularization, classification, dimensionality reduction, ensemble learning, meta learning, association rule learning, cluster analysis, anomaly detection, deep learning, or ultra-deep learning. ML may comprise: k-means, k-means clustering, k-nearest neighbors, learning vector quantization, linear regression, non-linear regression, least squares regression, partial least squares regression, logistic regression, stepwise regression, multivariate adaptive regression splines, ridge regression, principal component regression, least absolute shrinkage and selection operation (LASSO), least angle regression, canonical correlation analysis, factor analysis, independent component analysis, linear discriminant analysis, multidimensional scaling, non-negative matrix factorization, principal components analysis, principal coordinates analysis, projection pursuit, Sammon mapping, t-distributed stochastic neighbor embedding, AdaBoosting, boosting, gradient boosting, bootstrap aggregation, ensemble averaging, decision trees, conditional decision trees, boosted decision trees, gradient boosted decision trees, random forests, stacked generalization, Bayesian networks, Bayesian belief networks, naïve Bayes, Gaussian naïve Bayes, multinomial naïve Bayes, hidden Markov models, hierarchical hidden Markov models, support vector machines, encoders, decoders, auto-encoders, stacked auto-encoders, perceptrons, multi-layer perceptrons, artificial neural networks, feedforward neural networks, convolutional neural networks, recurrent neural networks, long short-term memory, deep belief networks, deep Boltzmann machines, deep convolutional neural networks, deep recurrent neural networks, large language models, vision transformers, or generative adversarial networks.

Training the ML model may include, in some cases, selecting one or more untrained data models to train using a training data set. The selected untrained data models may include any type of untrained ML models for supervised, semi-supervised, self-supervised, or unsupervised machine learning. The selected untrained data models may be specified based upon input (e.g., user input) specifying relevant parameters to use as predicted variables or other variables to use as potential explanatory variables. For example, the selected untrained data models may be specified to generate an output (e.g., a prediction) based upon the input. Conditions for training the ML model from the selected untrained data models may likewise be selected, such as limits on the ML model complexity or limits on the ML model refinement past a certain point. The ML model may be trained (e.g., via a computer system such as a server) using the training data set. In some cases, a first subset of the training data set may be selected to train the ML model. The selected untrained data models may then be trained on the first subset of training data set using appropriate ML techniques, based upon the type of ML model selected and any conditions specified for training the ML model. In some cases, due to the processing power requirements of training the ML model, the selected untrained data models may be trained using additional computing resources (e.g., cloud computing resources). Such training may continue, in some cases, until at least one aspect of the ML model is validated and meets selection criteria to be used as a predictive model.

In some cases, one or more aspects of the ML model may be validated using a second subset of the training data set (e.g., distinct from the first subset of the training data set) to determine accuracy and robustness of the ML model. Such validation may include applying the ML model to the second subset of the training data set to make predictions derived from the second subset of the training data. The ML model may then be evaluated to determine whether performance is sufficient based upon the derived predictions. The sufficiency criteria applied to the ML model may vary depending upon the size of the training data set available for training, the performance of previous iterations of trained models, or user-specified performance requirements. If the ML model does not achieve sufficient performance, additional training may be performed. Additional training may include refinement of the ML model or retraining on a different first subset of the training dataset, after which the new ML model may again be validated and assessed. When the ML model has achieved sufficient performance, in some cases, the ML may be stored for present or future use. The ML model may be stored as sets of parameter values or weights for analysis of further input (e.g., further relevant parameters to use as further predicted variables, further explanatory variables, further user interaction data, etc.), which may also include analysis logic or indications of model validity in some instances. In some cases, a plurality of ML models may be stored for generating predictions under different sets of input data conditions. In some embodiments, the ML model may be stored in a database (e.g., associated with a server).

### Examples of Neural Networks

The systems, the methods, the computer-readable media, and the techniques disclosed herein may implement one or more neural networks (NNs). NNs are a subset of machine learning and are often at the core of many deep learning algorithms. Neural networks may comprise node layers, each which may comprise one or more of an input layer, one or more hidden layers, and an output layer. Each node of a neural network may connect to another node of the neural network. Each node of a neural network may have an associated weight and threshold. In some cases, if an output from any individual node of a neural network is above a specified threshold value, that node is activated, thereby sending data to the next layer of the neural network; otherwise, no data is passed along to the next layer of the neural network.

Convolutional neural networks are a type of neural network that may be, in some cases, implemented by the systems, the methods, the computer-readable media, and the techniques disclosed herein. CNNs are often used for classification and computer vision tasks. Prior to CNNs, manual, time-consuming feature extraction methods were used to identify objects in images. However, CNNs provide a more scalable approach to image classification and object recognition tasks, leveraging principles from linear algebra, specifically matrix multiplication, to identify patterns within an image. That said, CNNs can be computationally demanding, using graphical processing units (GPUs) to train models.

CNNs may be distinguished from other neural networks by their superior performance with image, speech, or audio signal inputs. CNNs may comprise three main types of layers: convolutional layers, pooling layers, and fully-connected (FC) layers. The convolutional layer may be the first layer of a CNN. While convolutional layers can be followed by additional convolutional layers or pooling layers, the fully-connected layer may be the final layer of the CNN.

When applied to computer vision tasks within images, with each layer, the CNN increases in its complexity, identifying greater portions of the image. Earlier layers of a CNN may focus on simple features of an image, such as colors and edges. As the image data progresses through the layers of the CNN, the CNN starts to recognize larger elements or shapes of objects in the image until the CNN identifies the intended object.

The convolutional layer is a core building block of a CNN and may be where much of the computation of the CNN occurs. Convolution layers may use components including input data, a filter, and a feature map. Provided, for example, the input data comprises a color image (which e.g., includes a matrix of pixels in 3D), the input may have three dimensions-a height, width, and depth-which correspond to RGB in an image. CNNs may further comprise a feature detector (also known as a kernel or a filter), which moves across receptive fields of the image, checking if a feature is present. This process may be known as a convolution.

The feature detector may include a filter that is a two-dimensional array of weights, which represents part of an image. Filters of feature detectors may vary in size (e.g., 3×3 matrix), and the size may determine the size of the receptive field. The filter may be applied to an area of the image, and a dot product may be calculated between input pixels and the filter. The dot product may then be fed into an output array. Afterwards, the filter may shift by a stride, repeating the process until the filter has swept across the entire image. The final output from the series of dot products from the input and the filter may be known as a feature map, activation map, or a convolved feature. After each convolution operation, a CNN may apply a Rectified Linear Unit (ReLU) transformation to the feature map, introducing nonlinearity to the CNN.

In some cases, another convolution layer can follow the initial convolution layer of the CNN. For example, the structure of the CNN can become hierarchical as the later layers can see the pixels within the receptive fields of prior layers. As an example, assume a CNN used to determine if an image contains a bicycle. Each individual part of the bicycle (e.g., frame, handlebars, wheels, pedals, etc.) makes up a lower-level pattern in the CNN, and the combination of the parts represents a higher-level pattern, creating a feature hierarchy within the CNN.

The pooling layers, also known as downsampling, are further layers of a CNN. Pooling layers may conduct dimensionality reduction, reducing the number of parameters in the input (e.g., image, video, audio, etc.). Similar to the convolutional layer, the pooling layer sweeps a filter across the entire input, but, unlike the convolution layers, the filters of the pooling layers do not have any weights. Instead, the filters of the pooling layers apply an aggregation function to values within the receptive field, populating the output array. There are two main types of pooling: max pooling and average pooling. Max pooling may comprise moving the filter across the input to select the pixel with the maximum value to send to the output array. Average pooling may comprise moving the filter across the input to calculate the average value within the receptive field to send to the output array. While a lot of information is lost in the pooling layer, the pooling layer also has a number of benefits to the CNN. For example, pooling layers may help to reduce complexity CNN, improve efficiency, and limit risk of overfitting of the CNN.

Fully-connected layers are the final layer of a CNN. As previously disclosed, pixel values of an input image are not directly connected to output layers in partially connected layers. However, in the fully-connected layer, each node in the output layer connects directly to a node in the previous layer. The FC layer performs the task of classification based on the features extracted through the previous layers and their different filters. While convolutional layers and pooling layers tend to use ReLu functions, FC layers may leverage a softmax activation function to classify inputs appropriately, producing a probability from 0 to 1.

In some cases, the systems, the methods, the computer-readable media, and the techniques disclosed herein may implement deep neural networks. DNNs are neural networks with numerous layers. For example, some neural networks may be classified as DNNs provided the neural network has 3 or more layers, 4 or more layers, 5 or more layers, 6 or more layers, 7 or more layers, 8 or more layers, 9 or more layers, 10 or more layers, etc. In some cases, these layers may include an input and output layer. Accordingly, in some cases, a CNN may be considered an instance of a DNN.

Hyperparameters may be used in CNN architectures to indicate information such as a number of kernels in a convolutional layer, a size of kernels in a convolutional layer, a size of stride, a size of kernels in a pooling layer, etc. Hyperparameters may further be used in a CNN to indicate information such as how the CNN is trained; for example, learning rate, weights, biases, momentum, decay, etc. In some cases, hyperparameters for a CNN may be set prior to training the CNN.

### Examples of Methods for Training a CNN

As described above, the CNN model may be modified to be FHE compatible. In some cases, training the modified CNN model may comprise implementing hyperparameter selection based on criticality. In some cases, criticality may be monitored shortly after training begins and the critical point may be used to select the hyperparameter values. Such hyperparameters tuned for achieving criticality quickly may include initialization distributions, batch size, learning rate, and optimizer settings.

In some cases, the systems, the methods, the computer-readable media, and the techniques disclosed herein may use gaussian noise itself as an activation function when, e.g., used with FHE. Defining the gaussian noise activation function may include, for a given dataset and network structure, tuning the mean and variance of the gaussian noise.

In some cases, criticality may depend on self-organized criticality (SOC), which is a property of dynamical systems that have a critical point as an attractor. Their macroscopic behavior thus displays the spatial or temporal scale-invariance characteristic of the critical point of a phase transition, but without the need to tune control parameters to a precise value, because the system, effectively, tunes itself as it evolves towards criticality.

In some cases, when a system is at a critical point, the smallest nudge can cause non-linear changes. If a network approaches near enough to a critical point in hyperparameter space, then the network may have a good probability of training. Alternatively, if hyperparameters are set such that the system is too stable, the network either may not learn or may learn too slowly. Furthermore, if hyperparameters are set such that the system is too chaotic, the model may never approach one of the better local minima.

In some cases, the modified network may be harder to train (e.g., the network may be more finicky) due to the modified CNN architecture such as involving a non-traditional activation functions (e.g., x²) or removing pooling layers. In some cases, to ensure the convolutional layer has an appropriate number of parameters without pooling, the number of outputs one layer may be aligned with (e.g., having the same number) the input for the next layer. Accordingly, hyperparameters may be selected based at least in part on empirically observing loss dynamics as the network trains and then trying a different hyperparameter, in an iterative manner. For example, Code Excerpt 1 may depict a case where weights and biases are initialized differently with iris code.

Code Excerpt 1

torch. nn.init.normal_(module.weight, mean=−0.01, std=.146)
torch.nn.init.normal_(module.bias, mean=−0.1, std=.5)

And Code Excerpt 2 may depict a case where uniform distribution is used for weights with mnist code.

Code Excerpt 2

torch.nn.init.xavier_uniform_(module.weight)
torch.nn.init.normal_(module.bias, mean=0.01, std=.1)

In some cases, having asymmetry (e.g., a non-zero mean), may be important to set up a network training such that the network remains in the critical zone. Code Excerpt 3 may depict such network structure of iris code.

Code Excerpt 3

```
def _{——}init_{——}(self):
    super(Classifier, self)._{——}init_{——}( )
    self.fc1 = nn.Linear(4, 4).double( )
    self.fc2 = nn.Linear(4, 4).double( )
    self.fc3 = nn.Linear(4, 4).double( )
    self.fc4 = nn.Linear(4, 4).double( )
    self.fc5 = nn.Linear(4, 4).double( )
    self.fc6 = nn.Linear(4, 2).double( )
    self.fc7 = nn.Linear(2, 4).double( )
    self.fc8 = nn.Linear(4, 4).double( )
    self.fc_final = nn.Linear(4, 3).double( )
    self.criterion = nn.CrossEntropyLoss( )
  def activation(self, x):
    “““
    Custom activation function
    “““
    return x*x
  def forward(self, x):
    x = self.fc1(x)
    x = self.activation(x)
    x = self.fc2(x)
    x = self.activation(x)
    x = self.fc3(x)
    x = self.activation(x)
    x = self.fc4(x)
    x = self.activation(x)
    x = self.fc5(x)
    x = self.activation(x)
    x = self.fc6(x)
    x = self.activation(x)
    x = self.fc7(x)
    x = self.activation(x)
    x = self.fc8(x)
    x = self.activation(x)
    x = self.fc_final(x)
```

Furthermore, Code Excerpt 4 may further depict corresponding mnist code.

Code Excerpt 4

```
def _{——}init_{——}(self):
  super(DigitClassifier, self)._{——}init_{——}( )
  self.conv1 = torch.nn.Conv2d(1, 16, kernel_size=4, stride=2, padding=1)
  self.conv2 = torch.nn.Conv2d(16, 16, kernel_size=4, stride=2, padding=1)
  self.conv3 = torch.nn.Conv2d(16, 16, kernel_size=4, stride=2, padding=1)
  self.conv4 = torch.nn.Conv2d(16, 4, kernel_size=4, stride=2, padding=1)
  self.fc1 = nn.Linear(16, 16)
  self.fc_final = nn.Linear(16, 10)
  self.criterion = nn.CrossEntropyLoss( )
def forward(self, X):
  “““
  x : 2D Tensor of MNIST image
  “““
  batch_size = X.shape[0]
  X = X.unsqueeze(dim=1)
  X = self.conv1(X)
  X = expand_2(X)
  X = activation(X)
  X = self.conv2(X)
  X = activation(X)
  X = self.conv3(X)
  X = activation(X)
  X = self.conv4(X)
  X = activation(X)
  X= X.view(X.size(0), −1)
  X = self.fc1(X)
  X = activation(X)
  X = self.fc_final(X)
  return X
```

### Examples of Adversarial Machine Learning

As disclosed herein, in some cases, the systems, the methods, the computer-readable media, and the techniques disclosed herein may implement one or more adversarial machine learning techniques to create a robust, resilient AIS that protects AI systems.

Adversarial ML involves the study of ML systems under attack and may be important to understanding how to defend against these threats. The systems, the methods, the computer-readable media, and the techniques disclosed herein may use adversarial training techniques to make AI models more robust against adversarial attacks, enhancing their ability to identify and neutralize threats.

Generally, some example techniques for defense with respect to adversarial ML may include threat modeling (e.g., formulizing attacker goals and capabilities with respect to a target systems), attack simulation (e.g., formulizing an optimization problem an attacker tries to solve according to possible attack strategies), attack impact evaluation, countermeasure design, noise detection (e.g., for evasion based attacks), information laundering (e.g., alter information received by adversaries). Generally, some example mechanisms for defense with respect to adversarial ML may include secure learning algorithms, Byzantine-resilient algorithms, multiple classifier systems, AI-written algorithms, AIs that explore a training environment (e.g., in image recognition, actively navigating a 3D environment rather than passively scanning a fixed set of 2D images), privacy-preserving learning, ladder algorithm for Kaggle-style competitions, game theoretic models, sanitizing training data, adversarial training, backdoor detection algorithms, gradient masking/obfuscation techniques (e.g., to prevent an attacker from exploiting gradient in white-box attacks), etc.

More specifically, one technique for adversarial ML may be adversarial training. Adversarial training may include introducing adversarial examples (e.g., inputs designed to cause a ML model to make a mistake) into a training set for the ML model. By training the ML model on these adversarial examples, the ML model may learn to correctly classify them, thereby increasing robustness against such attacks.

Another technique for adversarial ML may be evasion attack training. Evasion attacks may include manipulating test inputs to mislead a ML model, resulting, for example, in incorrect classifications by the ML model. By integrating adversarial machine learning techniques, the AIS of the systems, the methods, the computer-readable media, and the techniques disclosed herein may become more resilient against such evasion attacks. Accordingly, the AIS can learn to identify when inputs have been subtly altered in attempts to deceive the system.

Another technique for adversarial ML may be poisoning attack mitigation. Data poisoning attacks may introduce harmful data into a training set for a ML model, aiming to manipulate the ML model's learning process. The AIS of the systems, the methods, the computer-readable media, and the techniques disclosed herein may use advanced detection algorithms to identify potential poisoning attempts, preserving the integrity of the training data and ensuring reliable model behavior.

Another technique for adversarial ML may be transfer learning. The systems, the methods, the computer-readable media, and the techniques disclosed herein may leverage the concept of transfer learning, where knowledge gained from one problem is applied to solve a different but related problem. In the context of adversarial machine learning, transfer learning may include applying insights from one type of attack to defend against other types of attacks, enhancing the overall protection. Accordingly, this may enable defending against new types of attacks that are at least partially related to previously-seen types of attacks.

Another technique for adversarial ML may be model hardening. The systems, the methods, the computer-readable media, and the techniques disclosed herein may apply model hardening to modify a ML model to reduce its vulnerability to attacks. Techniques may include feature squeezing (e.g., reducing the search space available to an adversary), defensive distillation (e.g., training the ML model to produce similar outputs for similar inputs), etc.

Advantageously, by integrating adversarial machine learning into AIS, the systems, the methods, the computer-readable media, and the techniques disclosed herein may enable an AI system to not only identify and respond to threats, but also become more resistant to attacks over time, contributing to the robustness, adaptability, and overall security of the AI system.

### Examples of Encryption Techniques

The systems, the methods, the computer-readable media, and the techniques disclosed herein may implement one or more encryption techniques to enable secure handling of sensitive data. In cryptography, encryption is the process of encoding information. This process may convert an original representation of the information (e.g., data), which may be referred to as plaintext, into an alternative form, which may be referred to as ciphertext. In some cases, if encryption is successful, only authorized parties can decipher a ciphertext back to plaintext and access the information. While encryption may not prevent interference, encryption may deny a would-be interceptor from accessing an intelligible representation of the information.

Generally, an encryption scheme may use a pseudo-random encryption key generated by an algorithm. It may be possible to decrypt the message without possessing the key but, for a well-designed encryption scheme, considerable computational resources and skills may be involved in doing so. On the other hand, an authorized recipient may easily decrypt the message with the key.

Homomorphic encryption is a form of encryption that may be applied herein to enable computations to be performed on encrypted data without first having to decrypt the encrypted data. The resulting computations may be left in an encrypted form which, when decrypted, may result in an output that is identical to that produced had the computations instead been performed on the unencrypted data. Advantageously, homomorphic encryption may be applied to privacy-preserving outsourced storage and computation (e.g., data may be encrypted and out-sourced to commercial cloud environments for processing-all while remaining encrypted). Accordingly, homomorphic encryption may be useful with sensitive data, such as health care information, where homomorphic encryption can be used to enable new services by removing privacy barriers inhibiting data sharing or increasing security to existing services.

Homomorphic encryption may include multiple types of encryption schemes that can perform different classes of computations over encrypted data. The computations may be represented as either Boolean or arithmetic circuits. Types of homomorphic encryption may include partially homomorphic encryption, somewhat homomorphic encryption, leveled fully homomorphic encryption, and fully homomorphic encryption. Homomorphic encryption may work with many types of encryption schemes or cryptosystems, including RSA, ElGamal, Goldwasser-Micali, Benaloh, FV, BGV, and Paillier.

Partially homomorphic encryption encompasses schemes that support the evaluation of circuits including one type of gate (e.g., addition or multiplication). Somewhat homomorphic encryption schemes can evaluate two types of gates for a subset of circuits. Leveled fully homomorphic encryption may support the evaluation of arbitrary circuits including multiple types of gates of bounded (pre-determined) depth. FHE may enable the evaluation of arbitrary circuits including multiple types of gates of unbounded depth and may be the strongest notion of homomorphic encryption.

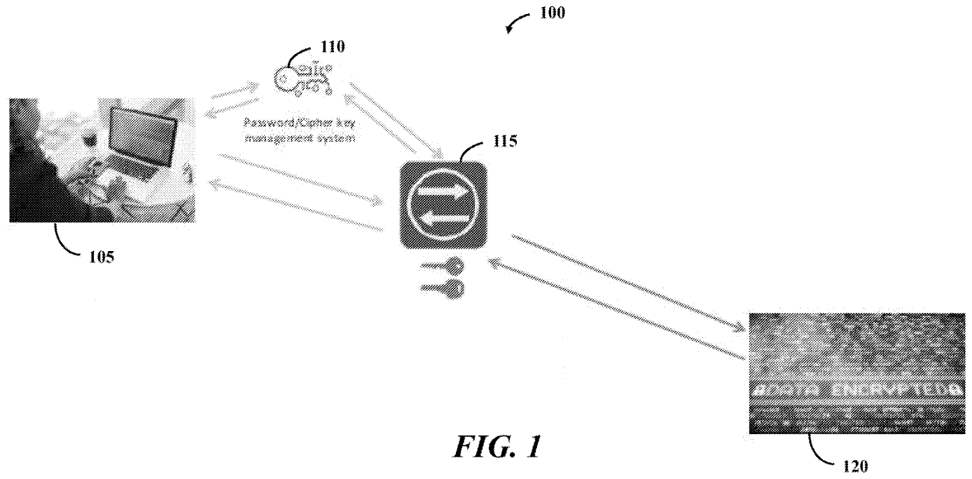

FIG. 1 shows an example process 100 for implementing a trusted AI. As illustrated in the process 100, encrypted data may be used to implement secure data requests. In some cases, a user application (e.g., browser-based, desktop, mobile, etc.) 105 that is operated by the user may send out commands. These commands may correspond to inputs from a user, such as a search. In some cases, once the user application 105 sends out the commands, an agent 115 may transform the commands from unencrypted (e.g., plaintext) commands into encrypted (e.g., via homomorphic encryption, such as partially homomorphic encryption, somewhat homomorphic encryption, leveled fully homomorphic encryption, FHE, etc.), commands. The encrypted commands may perform actions (e.g., computations) over encrypted data 120, thereby generating encrypted results. The encrypted results may then be decrypted by the agent 115 before being presented at the user application 105. In some cases, the agent 115 may be included on a computing device that may be remote with respect to the user. For example, the agent 115 may be a server. In some cases, the agent 115 may be co-located with respect to the user. For example, the agent 115 may be an application hosted on the same device as the user application 105, on a device that may be in direct communication with the device running the user application 105, on an Application Programming Interface (API) that is callable by the user application 105 (e.g., directly or indirectly), etc. In some cases, the agent 115 may operate in conjunction with a password (e.g., cipher key) management system 110 that may be used for encrypting or decrypting data. For example, the password management system 110 may be an application that is hosted on the same device as the user application 105, on a device that may be in direct communication with the device running the user application 105, on an API that is callable by the user application 105 (e.g., directly or indirectly), etc.

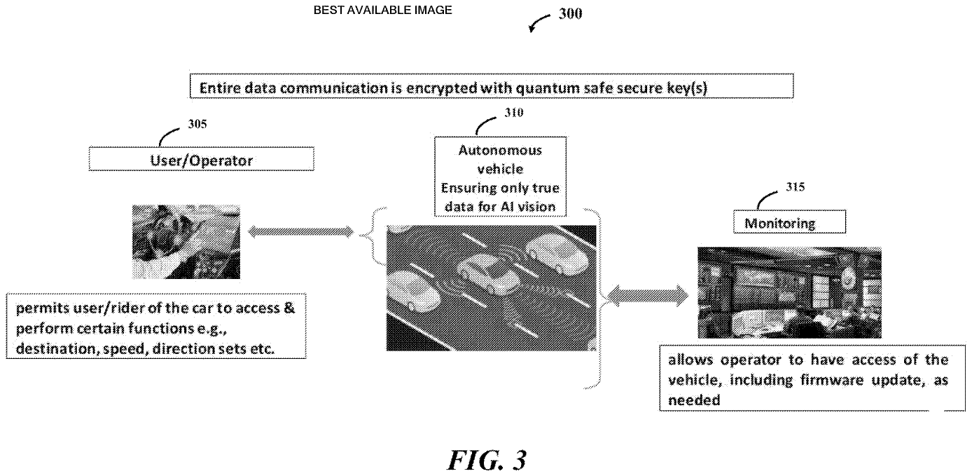

FIG. 3 shows an example application 300 implementing methods and the trusted AI systems herein with respect to autonomous vehicles. As illustrated, data used for autonomous vehicle operations may be encrypted end-to-end using one or more quantum safe secure keys. For example, a user/operator (e.g., driver, rider, etc.) 305 may be able to provide certain commands to an application in an autonomous vehicle 310. These commands may include vehicle commands such as destination, speed, directions, route preferences, time of arrival, driving style, entertainment preferences, etc.

The autonomous vehicle 310 may be monitored by a monitor 315. The monitor 315 may include a human, a computer system, an AI/ML model, etc. As disclosed herein, data sent from the autonomous vehicle 310 may be encrypted such that the monitor 315 receives encrypted data to perform action (e.g., computation) upon. In encrypting the data prior to the monitor 315 receiving the data, the user/operator 305 of the autonomous vehicle 310 may have their data protected from a third-party intercepting the data and may also have privacy of the data preserved once the data is received (e.g., viewed) by the monitor 315.

Data exchanged among the autonomous vehicle 310, remote control station 315 and various components of the system may be encrypted and AI-based analysis may be performed on the encrypted data directly ensuring the data integrity. The AI-based analysis may employ CNN or DNN with the modified architecture as described above such that the computation result may approximate the result that is based on plaintext data (original unencrypted data). Once monitor 315 performs the actions on the data, generating the result data, the result data may be decrypted once received by the autonomous vehicle 310.

In some cases, much of the computation may be done at the autonomous vehicle 310 by encrypting the data received from sensors of the autonomous vehicle 310. Furthermore, in some cases, the computation may also include performing inferences over the encrypted data to generate the driving environment and instructions on how to drive the autonomous vehicle 310 to a destination issued by the user/operator 305 or by the monitor 315.

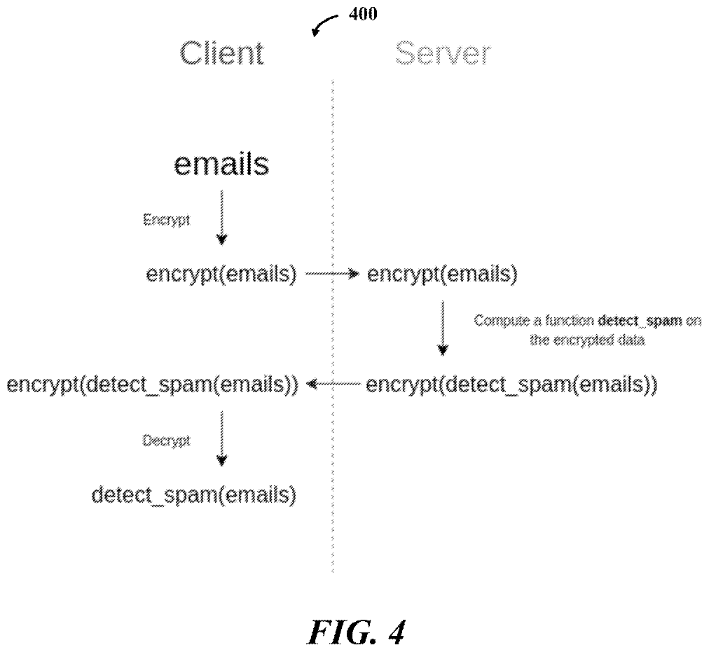

FIG. 4 shows an application 400 of the systems, the methods, the computer-readable media, and the techniques disclosed herein with respect to emails. The use case 400 illustrated in FIG. 4 for the use case of emails may be the same as or similar to the process 100 illustrated with respect to FIG. 1 or the use case 300 illustrated with respect to FIG. 3. For example, as illustrated in FIG. 4, a plurality of emails may be encrypted (e.g., via homomorphic encryption) on a client end and sent to a server as encrypted emails. The server may perform one or more actions (e.g., computations) on the encrypted emails. For example, as illustrated, the server may perform a spam detection algorithm on the encrypted emails, thereby generating an encrypted result. The encrypted result may be sent back to the client. The encrypted result may be decrypted by the client, thereby generating a decrypted result. For example, as illustrated, the decrypted result may include a decrypted detection of spam emails from the plurality of emails.

### Examples of Fully Homomorphic Encryption

As described, a cryptosystem that supports arbitrary computation on ciphertexts may be referred to as FHE. Through using FHE, the systems, the methods, the computer-readable media, and the techniques disclosed herein may enable performing of computations on encrypted data without needing to decrypt the data first, thereby enabling maintaining of data privacy throughout a data processing pipeline

In some cases, FHE may enable the construction of programs for any desirable functionality, which can be run on encrypted inputs to produce an encryption of the result. Since such a program may not decrypt its inputs, the program can be run by an untrusted party without revealing inputs and internal state. FHE techniques have been through numerous iterations, including partial implementations such as RSA cryptosystem (unbounded number of modular multiplications), ElGamal cryptosystem (unbounded number of modular multiplications), Goldwasser-Micali cryptosystem (unbounded number of exclusive or operations), Benaloh cryptosystem (unbounded number of modular additions), Paillier cryptosystem (unbounded number of modular additions), Sander-Young-Yung system (implements logarithmic depth circuits), Boneh-Goh-Nissim cryptosystem (unlimited number of addition operations but at most one multiplication), Ishai-Paskin cryptosystem (polynomial-size branching programs), etc.

There are several implementations of fully homomorphic encryption schemes. Second-generation and fourth-generation FHE scheme implementations may operate in a leveled FHE mode (though bootstrapping may still be available in some libraries) and support efficient SIMD-like packing of data (e.g., these implementations may be used to compute on encrypted integers or real/complex numbers). Third-generation FHE scheme implementations may bootstrap after each operation but may have limited support for packing (e.g., these implementations may be used to compute Boolean circuits over encrypted bits, support integer arithmetics and univariate function evaluation, etc.). The choice of using a second-generation vs. third-generation vs. fourth-generation scheme may depends on input data types and types of applied computation. Certain iterations of FHE may be open-source. For example, open source FHE libraries may implement second-generation (BGV/BFV), third-generation (FHEW/TFHE), or fourth-generation (CKKS) FHE schemes. Such FHE schemes may include HElib, Microsoft SEAL, OpenFHE, PALISADE, HEAAN, FHEW, TFHE, FV-NFLlib, NuFHE, REDcuFHE, Lattigo, TFHE-rs, Concrete, E3, SHEEP, T2, etc.

Generally, in implementing FHE, the systems, the methods, the computer-readable media, and the techniques disclosed herein may enable the evaluation of arbitrary circuits made up of multiple gate types of unbounded depth and FHE can be used in more complicated data security situations to help overcome mobile network challenges. Specific example applications of FHE to the systems, the methods, the computer-readable media, and the techniques disclosed herein may include privacy preserving computations, secure data sharing, enhanced AI model privacy, robustness against inference attacks, etc.

Turning to privacy-preserving computations: through implementing FHE, the AIS of the systems, the methods, the computer-readable media, and the techniques disclosed herein can conduct privacy-preserving computations, performing analyses and generating insights while ensuring that raw data (e.g., unencrypted data) remains confidential. Implementing FHE may be particularly important when dealing with sensitive data such as personal identifiers, financial information, healthcare information, election/voting information, trade secret information, etc. any of which are often targeted in cyber-attacks.

Turning to secure data sharing: through implementing FHE, the AIS of the systems, the methods, the computer-readable media, and the techniques disclosed herein may also facilitate secure data sharing between different entities. For example, different parts of a ML model may be hosted by different parties, each performing computations on their own encrypted data. The results may then be combined to obtain a final output, without any party having to reveal their raw data.

Turning to enhanced AI model privacy: through implementing FHE, the AIS of the systems, the methods, the computer-readable media, and the techniques disclosed herein may protect the privacy of ML models themselves. This is particularly important in scenarios where ML models are deployed in untrusted environments. By keeping the model encrypted, FHE may help to prevent model extraction attacks, where attackers aim to replicate the ML model's capabilities.

Turning to robustness against inference attacks: through implementing FHE, the AIS of the systems, the methods, the computer-readable media, and the techniques disclosed herein may help defend against inference attacks, where an attacker aims to retrieve sensitive information by querying a ML model. Since computations are performed on encrypted data by implanting FHE, an attacker may be unable to infer any meaningful information from responses.

The systems, the methods, the computer-readable media, and the techniques disclosed herein optimize the combination of FHE tuned to the AI problem space. While there are multiple FHE schemes available, in some cases, the systems, the methods, the computer-readable media, and the techniques disclosed herein may implement FHE schemes that are quantum-safe, even if more complex.

For example, the CKKS scheme is a quantum-safe homomorphic encryption scheme that can efficiently perform computations on floating-point (decimal) numbers and may be implemented, in some cases, by the systems, the methods, the computer-readable media, and the techniques disclosed herein. These cryptographically secure schemes may add random noise into the data during encryption. This noise is amplified during computations, but as long as the noise remains low enough, encrypted data can still be decrypted. Homomorphic encryption schemes may become FHE schemes (e.g., fully homomorphic and quantum-safe) when a specific operation called bootstrapping is implemented and “resets” the noise so that computations can continue indefinitely. In some cases, the systems, the methods, the computer-readable media, and the techniques disclosed herein deliver FHE for these AI-based use cases. In some cases, once data is encrypted with the quantum-safe FHE scheme of the systems, the methods, the computer-readable media, and the techniques disclosed herein, the data may not need to be decrypted in order to have analysis (e.g., computations) performed.

Training and utilizing AI models over FHE data may inherently be challenging. For example, some FHE operations carry a large overhead which makes these encrypted computations slower than their unencrypted counterparts. Open-source libraries may be used in both the FHE and AI/ML domains. For implementing FHE, libraries may include OpenFHE, Microsoft's SEAL, etc. Examples of potentially compatible AI/ML models may include scikit-learn, TensorFlow, PyTorch, etc. Yet combining such AI models with FHE may still have certain challenges. These challenges may be due to the limitations imposed by standard FHE implementations on allowed mathematical operations. By their very nature, AI and ML algorithms may use nonlinear mathematical operators, while FHE matrix operations are may use multiplication and addition.

Addressing these challenges within the constraints imposed by FHE may include combining a variety of diverse techniques and new holistic design approaches such as: using deep neural network architectures, using simple approximators for standard nonlinear operators such as exponentials and roots, using function substitutions, using hyper-vector computing and bitwise operators, etc.

For example, two dense neural network-based AI models may be trained on plaintext but using FHE to provide inferences in order to help address these challenges. Public datasets may be used for plaintext training and for FHE inferences. In some cases, a variety of AI models may be trained over encrypted data, for example, a CNN may be trained for image recognition and validation, which could be applicable for biometric identification. A three-operation method may be used for developing and releasing AI models over FHE-encrypted data aimed at countering identity threats, including: (A) developing and implementing plaintext-trained CNN AI models for FHE encrypted data inferences, including (i) identifying and testing FHE-appropriate approximations and alternatives for various nonlinear activation and loss functions, and (ii) systematically building increasingly large and more complex CNN models; (B) developing and implementing CNN (and, possibly, other) AI models for encrypted data in FHE domain, including (i) creating mathematical models to prove homomorphic encryption-based similarity calculations, and (ii) using knowledge gained in creating the mathematical models, to systematically build increasingly large and more complex AI models, including other DNNs (e.g., targeted for DHS use); and (C) providing products and APIs for use of the FHE based AI models.

Implementing quantum-safe encrypted AI models will allow individuals to encrypt their own data, which will ensure user privacy and minimize identity fraud and theft. In a real-world setting, such encrypted models may be used by for biometric identity verification (e.g., for travel security), or to identify containers that pose a potential risk for terrorism, drugs, or other contraband (e.g., for boarder/customs security). Having AI models built upon and utilizing encrypted data may provide an additional layer of cyberspace privacy and security.

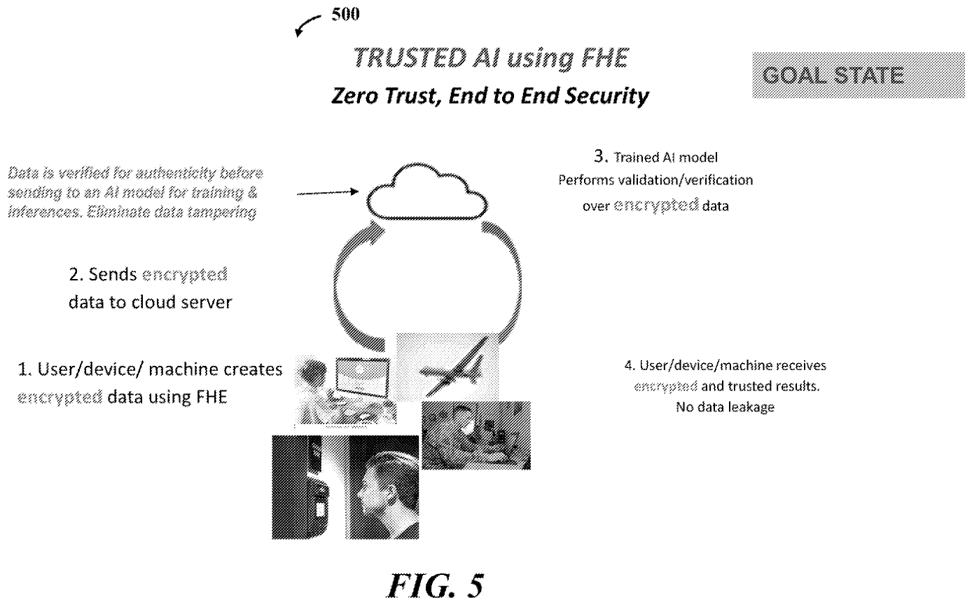

FIG. 5 shows an example process 500 of implementing trusted AI using Fully Homomorphic Encryption. As illustrated, the process of FIG. 5 may operate in a zero trust environment and provide end-to-end security.

The process 500 may begin, in some cases, with a user/device/machine generating encrypted data using fully homomorphic encryption. While FHE is illustrated as being used in FIG. 5 and presents certain advantages (as, e.g., disclosed herein), in some cases, other suitable encryption techniques may be used to achieve results that may have at least certain similarities to those disclosed herein with respect to FHE. The encrypted data may be sent to a server (e.g., a cloud server). At the server the encrypted data may be verified for authenticity before sending the encrypted data to an AI/ML model. The AI/ML model may then perform validation, verification, training, inferences, etc. over the encrypted data. Then the user/device/machine may receive encrypted and trusted results from the AI/ML model.

Advantageously, by implementing FHE into AIS, the systems, the methods, the computer-readable media, and the techniques disclosed herein may ensure that data privacy is maintained while still being able to leverage the power of AI to detect and respond to threats. This technique may further ensure the confidentiality and integrity of data, enhancing user trust in AI systems.

Examples of Neural Networks with Modified Architecture for FHE Data

The systems, the methods, the computer-readable media, and the techniques disclosed herein provide for artificial intelligence in which computations are performed on encrypted (via FHE) values in such a way that (1) decryption is arbitrarily and provably difficult, and (2) outcomes are consistent with some given plain-text (PT) computation. In some cases, the FHE computation need not mirror the PT computation to generate consistent outputs.

In some embodiments, the present disclosure provides a DNN-based model with modified architecture that is suitable for FHE computation. The term “modified architecture” as utilized herein may generally refer to having one or more components of a deep learning network modified to be suitable for FHE computation. In some cases, the modified architecture may comprise using a Gaussian function as an activation function. In some cases, the modified architecture may comprise removing one or more pooling layers. In some cases, the DNN-based model may be trained on plaintext data, encrypted data (FHE encrypted) or a combination of both. The trained DNN-model may be deployed to make inference based on FHE encrypted data.

The model architecture may be modified to be suitable for FHE computation thereby improving computation efficiency and accuracy of the result compared to the computation performed on plaintext data. For example, ReLU (rectified linear unit) may be an optimal activation function to be used in PT models. In that domain ReLU may be both efficient and conducive to training accurate models. In FHE, by contrast, a ReLU may not be efficient to calculate. Some practitioners indicate that an approximation with almost sixty terms may be used to model ReLU sufficiently faithfully in FHE.

Another design example that is optimal in PT may be “pooling,” a process for processing the output of convolution layers. While pooling can be useful in some cases, pooling can also be avoided in the network design, allowing for a network with fewer overall operations. Given the same accuracy, fewer operations may be preferable, but even more so under FHE because computation may be much more costly in FHE. In FHE, neural networks may, in some cases, not use pooling. In such cases, the pooling layers may simply be removed, and the now-interacting convolutional layers may be appropriately adjusted to have a certain number of parameters. Additionally, in some cases, the ReLU functions may be replaced by x².

In some cases, activation functions may be used because activation functions may create non-linearities between layers. For example, without activation functions, there may be no mathematical benefit for having multiple layers. With those nonlinearities, a network may be able to bifurcate signals without the signals merging again after. In some cases, a completed network may employ a plurality of such bifurcations, configured in a network, to perform more complex tasks, such as multi-class labeling, or regression. In some cases, a ReLU may perform bifurcation by making some signals positive and other signals zero-those may be the two states of interest. For x², the two states of interest may be near-zero and far-from-zero. It is with these two states that x² may be able to bifurcate signals. Further, in some cases, precisely defined gaussian noise may act as an activation function. The noise activation function may mirror x² almost exactly and lead to similar accuracies when trained.

In some cases, the DNN-based network with the modified architecture may be difficult to train. The present disclosure may provide an improved method for training the modified DNN-model. In some cases, during a training phase to train the DNN-based model with the modified architecture, the method may comprise selecting hyperparameter values based on criticality. For instance, the method may comprise selecting values for one or more hyperparameters based at least in part on monitoring criticality. In some cases, the one or more hyperparameters may include at least one of mean and variance of the random initialization distributions, batch size, learning rate, or optimizer settings. In some cases, a mean or variance of the Gaussian function is tuned during the training phase. Once trained, the benefit of such a network may be that the network runs more quickly in FHE than the standard network design.

### Examples of Blockchain Techniques

The systems, the methods, the computer-readable media, and the techniques disclosed herein may implement a blockchain. The blockchain implemented by the systems, the methods, the computer-readable media, and the techniques disclosed herein may form an important component of AIS techniques.

A blockchain (which may also be referred to e.g., as a distributed ledger or a shared ledger) is a technique that may be used for achieving a distributed consensus on validity or invalidity of information in a chain. In other words, the blockchain provides a decentralized trust to participants and observers. As opposed to using a central authority, a blockchain is a distributed database, or ledger, in which a transactional record may be maintained at each node of a peer to peer network.

The distributed ledger may be comprised of groupings of transactions bundled together into a “block,” and ordered sequentially (thus the term “blockchain”). Nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what may be referred to as a distributed ledger network. The nodes in the distributed ledger network may validate changes to the blockchain (e.g., when a new transaction or block is created) according to a set of consensus rules, where each node forms a consensus as to how the change is integrated into the distributed ledger. The consensus rules may depend on the information being tracked by the blockchain and may include rules regarding the chain itself. For example, a consensus rule may include that the originator of a change supply a proof-of-identity such that only approved entities may originate changes to the chain. A consensus rule may include that blocks and transactions adhere to format requirement and supply certain meta information regarding the change (e.g., blocks are required to be below a size limit, transactions are required to include a number of fields, etc.). Consensus rules may include a mechanism to determine the order in which new blocks are added to the chain (e.g., through a proof-of-work system, proof-of-stake, etc.).

Upon consensus, the agreed upon change is pushed out to each node so that each node maintains a copy (e.g., identical copy) of the updated distributed ledger. For example, additions to the blockchain that satisfy the consensus rules may be propagated from nodes that have validated the addition to other nodes that the validating node is aware of. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule may be disregarded by validating nodes that receive the change and may not be propagated to other nodes. Accordingly, unlike a central authority, a single party cannot unilaterally alter the distributed ledger, unless the single party can do so in a way that satisfies the consensus rules. This inability to modify past transactions leads to blockchains being generally described as trusted, secure, and immutable.

The validation activities of nodes applying consensus rules on a blockchain network may take various forms. For example, the blockchain may be viewed as a shared spreadsheet that tracks data such as the ownership of assets. In another example, the validating nodes execute code contained in “smart contracts” and distributed consensus is expressed as the network nodes agreeing on the output of the executed code.

A smart contract may be a computer protocol that enables the automatic execution or enforcement of an agreement between different parties. In particular, the smart contract may be computer code that is located at a particular address on the blockchain. In some cases the smart contract may run automatically in response to a participant in the blockchain sending funds (e.g., a cryptocurrency such as bitcoin, ether, or other digital or virtual currencies) to an address where the smart contract is stored. Additionally, smart contracts may maintain a balance of the amount of funds that are stored at their address. In some cases, when this balance reaches zero the smart contract may no longer be operational. The smart contract may include one or more trigger conditions, that, when satisfied, correspond to one or more actions. For some smart contracts, which actions from the one or more actions are performed may be determined based at least in part on one or more decision conditions. In some cases, data streams may be routed to the smart contract so that the smart contract may detect that a trigger condition has occurred or analyze a decision condition.

Some blockchains may be deployed in an open, decentralized, and permissionless manner meaning that any party may view information, submit new information, or join the blockchain as a node responsible for confirming information. This open, decentralized, and permissionless approach to a blockchain may have certain limitations. As an example, these blockchains may not be good candidates for interactions that require information to be kept private or for interactions that require all participants to be vetted prior to their participation.

Other blockchains may be deployed as private (e.g., permissioned ledgers) blockchains that keep chain data private among a group of entities authorized to participate in the blockchain network. Other blockchain implementations may be both permissioned and permissionless whereby participants may need to be validated, but only the information that participants in the network wish to be public is made public.

In some cases, to create a new block in a blockchain, each transaction within a block may be assigned a checksum value that may also be referred to as a hash (e.g., an output of a cryptographic hash function, such as SHA-256 or MD5). These checksum values may then be combined together utilizing data storage and cryptographic techniques (e.g., a Merkle Tree) to generate a checksum value representative of the entire new block, and consequently the transactions stored in the block. This checksum value may then be combined with the checksum value of the previous block to form a checksum value included in the header of the new block, thereby cryptographically linking the new block to the blockchain. In some embodiments, the one or more associated transactions are used as a verification point for the unique watermark identifier, which serves as a checksum for the plaintext data. To this end, the precise value utilized in the header of the new block may be dependent on the checksum value for each transaction in the new block, as well as the checksum value for each transaction in every prior block.

In some cases, information stored in blockchains may be trusted (e.g., at least partially trusted), because the checksum value generated for the new block and a nonce value (an arbitrary number used once) may be used as inputs into a cryptographic puzzle. The cryptographic puzzle may have a difficulty set by the nodes connected to the blockchain network, or the difficulty may be set by administrators of the blockchain network. In one example of the cryptographic puzzle, a solving node uses the checksum value generated for the new block and repeatedly changes the value of the nonce until a solution for the puzzle is found. For example, finding the solution to the cryptographic puzzle may involve finding the nonce value that meets certain criteria (e.g., the nonce value begins with five zeros).

When a solution to the cryptographic puzzle is found, the solving node publishes the solution and the other nodes may then verify that the solution is valid. Since the solution may depend on the particular checksum values for each transaction within the blockchain, if the solving node attempts to modify any transaction stored in the blockchain, the solution may not be verified by the other nodes. More specifically, if a single node attempts to modify a prior transaction within the blockchain, a cascade of different checksum values may be generated for each tier of the cryptographic combination technique. This may result in the header for one or more blocks being different than a corresponding header in every other node that did not make the exact same modification.

In some cases, checksums of a blockchain may be used in blockchain for verification and ensuring non-repudiated data when paired with steganography and watermarking. The use of steganography and watermarking, paired with checksums in blockchain databases, ensures both the verifiability and non-repudiation of data, thereby providing data trustworthiness, allowing for highly secure transactions and reliable data management. In other words, the blockchain-based checksum verification may ensure that decrypted data has not been tampered with, providing non-repudiation of data.

Turning to the AIS of the systems, the methods, the computer-readable media, and the techniques disclosed herein, because a blockchain may maintain a transparent and tamper-proof record of all transactions, blockchain may be integrated within AIS, as blockchain may help create an immutable audit trail of all activities within a system. For example, this real-time record of events included in a blockchain may enable rapid identification of anomalies, providing key insights for quick and decisive actions when threats are detected.

Furthermore, because blockchain is decentralized, meaning the data is distributed across multiple nodes or computers, applying blockchain to AIS may ensure there is no single point of failure, thereby further enhancing a system's resilience to attacks. For example, in the event of an intrusion, a compromised node can be isolated and repaired without affecting function of the entire system.

As disclosed herein, blockchain can be programmed with smart contracts (e.g., self-executing contracts with the terms of the agreement written into code). In the context of an AIS, smart contracts can automate responses to detected threats, reducing response times and minimizing potential damage. For example, a smart contract may automatically limit access for a suspicious user or isolate a potentially compromised node.

As disclosed herein blockchain may implement various consensus mechanisms. Blockchain's consensus mechanisms can be utilized within AIS for trust establishment in the AIS. For example, before an AI model is updated, multiple nodes may validate a proposed update to the AI model. This may prevent unauthorized or malicious modifications to the AI model.

Blockchain also offers potential for improved privacy and data control within AIS. By combining blockchain technology with other techniques like SMPC or FHE, sensitive data can be securely stored and processed without revealing it to unauthorized entities. This approach of melding AI with FHE to emulate artificial immune systems, enabling an autonomous, self-learning, and resilient system for data protection may hinge on the core technologies that may be deftly interwoven, such as SMPC, the utilization of application-specific integrated circuits (ASICs) and optical processors for high-performance FHE, hypervectors and vector symbolic architectures (VSAs), and steganography and watermarking with checksums in blockchain databases. In some cases, the use of SMPC provides data privacy even while processing, while ASIC and optical processors bring new levels of efficiency and speed to FHE computation, making it practical for a broad range of applications. Hypervectors and VSAs may be further employed to effectively represent and manipulate complex symbolic structures, further expanding the capacities of the systems, the methods, the computer-readable media, and the techniques disclosed herein.

Through these features, blockchain technology offers significant benefits with application to AIS, bolstering the ability of the systems, the methods, the computer-readable media, and the techniques disclosed herein to maintain secure, transparent, and trustworthy AI operations.

### Examples of Secure Multi-Party Computation

The systems, the methods, the computer-readable media, and the techniques disclosed herein may implement Secure Multi-Party Computation for building robust and privacy-preserving AIS. Generally, SMPC is an interactive protocol for computing some functions (represented as circuits) between multiple parties. Depending on the type of circuit, there are two primary methods to implement SMPC. A garbled circuit is efficient for boolean circuits, while performing SMPC over shares of a secret is useful for arithmetic circuits. The SMPC protocol has the advantage of being information theoretical secure rather than relying on computational assumption as long as there is no collusion. Data may be secret-shared rather than encrypted. Shares on each server reveal no information about the secrets without all servers colluding with each other.

In some cases, SMPC may be referred to as secure computation, multi-party computation (MPC) or privacy-preserving computation. SMPC is a subfield of cryptography that may enable for parties to jointly compute a function over their inputs while keeping those inputs private. Unlike certain cryptographic techniques that may provide security and integrity of communication or storage with the adversary outside the system of participants (e.g., an eavesdropper on the sender and receiver), the cryptography in SMPC protects participants' privacy from each other. Example implementations of SMPC may include Yao-based protocols, SEPIA (Security through Private Information Aggregation), SCAPI) Secure Computation API), PALISADE (homomorphic encryption library), MP-SPDZ (versatile framework for multi-party computation), etc.

Generally, application of SMPC to the systems, the methods, the computer-readable media, and the techniques disclosed herein, may allow multiple parties to perform computations on their private inputs, while maintaining the privacy of these inputs.

Using SMPC, the systems, the methods, the computer-readable media, and the techniques may enable privacy-preserving collaborative learning. For example, different entities can train a shared AI model using their private data, without revealing their data to others. This may promote data-driven collaboration across organizations, leading to better trained models while ensuring data privacy.

SMPC may allow AIS to perform distributed threat detection and response. For example, when applied to AIS, the systems, the methods, the computer-readable media, and the techniques disclosed herein may leverage data and resources from different nodes to detect and mitigate threats, without any single node having access to all data. This distribution not only enhances privacy but also reduces the risk of a single point of failure.

In some cases, AIS can aggregate insights from different nodes securely using SMPC. In such cases, each node may process its local data and share only information used for aggregation. Accordingly, this technique may maintain the privacy of local data, while allowing collective insights to inform system-wide defense strategies.

By distributing the data processing and decision-making processes across multiple nodes, in some cases, the systems, the methods, the computer-readable media, and the techniques disclosed herein reduces the risk of data poisoning attacks using the AIS. Even if one node is compromised and fed poisoned data, for example, the impact on the overall system can be mitigated as decisions are made collectively.

Accordingly, SMPC may enable collaborative anomaly detection where different nodes can work together to detect anomalies. For example, each node can process its local data to identify potential anomalies, and these findings can be securely aggregated to identify system-wide anomalies. Advantageously, incorporating SMPC into AIS of the systems, the methods, the computer-readable media, and the techniques disclosed herein creates a secure, distributed, and collaborative defense system capable of protecting AI services from a variety of threats while ensuring the privacy and security of sensitive data.

### Examples of Stochastic Computing

The systems, the methods, the computer-readable media, and the techniques disclosed herein may implement stochastic computing for improving robustness, fault tolerance, and hardware efficiency, alongside reducing effectiveness of adversarial attacks. SC may be a technique for computation that treats data as probabilities. SC may have applications in massively parallel systems and is very tolerant of soft errors. Further, SC may be able to efficiently perform tasks such as communication decoding and neural network inference. Certain applications of SC may include implementing arithmetic operations by means of tiny logic circuits, benefited by redundant and highly error-tolerant data formats and low precision levels (e.g., comparable to analog computing) of SC.

To view certain strengths of SC, suppose one wishes to multiply two numbers each with n bits of precision. Using the typical long multiplication method, one would perform 2ⁿ operations. With stochastic computing, one can AND together any number of bits and the expected value will be correct (e.g., however, with a small number of samples the variance may render the actual result highly inaccurate). Moreover, the underlying operations in a digital multiplier may be full adders, whereas a stochastic computer only uses an AND gate. Additionally, a digital multiplier may naïvely use 2n input wires, whereas a stochastic multiplier may use 2 input wires. Additionally, stochastic computing may be robust against noise; for example, if a few bits in a stream are flipped, those errors may have minimal to no impact on the solution. Furthermore, stochastic computing elements may be able to tolerate skew in the arrival time of the inputs; circuits work properly even when the inputs are misaligned temporally. Accordingly, stochastic systems can be designed to work with inexpensive locally generated clocks instead of using a global clock and an expensive clock distribution network. Finally, stochastic computing may provide an estimate of a solution that grows more accurate the bit stream extends. In particular, stochastic systems may provide a rough estimate very rapidly. This property may be referred to as progressive precision, which suggests that the precision of SNs (e.g., bit streams) increases as computation proceeds. In other words, it is as if the most significant bits of the number arrive before its least significant bits; unlike other arithmetic circuits where the most significant bits usually arrive last. In some iterative systems, partial solutions obtained through progressive precision can provide faster feedback than through traditional computing methods, leading to faster convergence.

In some cases, each bit of an N-bit stochastic number (SN) X is randomly chosen to be 1 with some probability p_{X}, and X is generated and processed by conventional logic circuits. In other words, SNs may have where the xᵢ bits that are randomly chosen to make X's value be the probability p_{X} that xᵢ=1. Again, the resulting data values are in the unit interval [0,1]. For example, a single AND gate performs multiplication. The value X of a SN may be measured by the density of Is in the SN, an information-coding scheme also found in biological neural systems.

In some cases, interpreting SNs as probabilities may limits them to the unit interval [0,1]. As such, to implement arithmetic operations outside this interval, the number range may be scaled in application-dependent ways. For example, integers in the range [0,256] may be mapped to [0,1] by dividing them by a scaling factor of 256, so that {0, 1, 2, . . . , 255, 256} is replaced by {0, 1/256, 2/256, . . . , 255/256, 1}. Such scaling may be a preprocessing step used with SC.

In some cases, SC can readily be defined to handle signed numbers. For example, a SN X, whose numerical value is interpreted as p_{X} may be referred to as having a unipolar format. To accommodate negative numbers, SC techniques may employ a bipolar format where the value of X may be interpreted as 2p_{X}−1, such that the SC range effectively becomes [−1, 1]. Thus, an all-0 bit-stream may have unipolar value 0 and bipolar value −1, while a bit-stream with equal numbers of 0's and 1's may have a unipolar value 0.5, but bipolar value 0.

Several types of SN formats may be used to implement SC. For example, SN formats may include unipolar (having p_{X} relation to p_{X}), bipolar (having 2p_{X}−1 relation to p_{X}), inverted bipolar (having 1−2p_{X} relation to p_{X}), ratio of 1's to 0's (having p_{X}/(1−p_{X}) relation to p_{X}), etc.

In some cases, SC may be applied for decoding of certain error correcting codes. For example, a probabilistic XOR operation and an averaging operation, which may be used for belief propagation, may be modeled with SC. Moreover, since, in some cases, a belief propagation algorithm may be iterative, SC provides partial solutions that may lead to faster convergence. Hardware implementations of stochastic decoders may be built on FPGAs.

The systems, the methods, the computer-readable media, and the techniques disclosed herein may apply SC into AIS by representing data as random bit streams rather than fixed point or floating-point numbers, offering unique advantages in terms of robustness, fault tolerance, and hardware efficiency. For example, advantages of SC the systems, the methods, the computer-readable media, and the techniques disclosed herein may include robustness against adversarial attacks, strong fault tolerance, efficient hardware utilization, parallel processing, noise resilience, etc.

Turning to robustness against adversarial attacks: through implementing SC and, accordingly, the inherent randomness of SC, it may become more difficult for adversaries to manipulate AI systems to produce a desired outcome. For example, even small changes in an input may not result in predictable changes in an output, making adversarial attacks less effective against AI systems implementing SC with AIS.

Turning to fault tolerance: through implementing SC and, accordingly, the probabilistic nature of SC, AI systems may become inherently fault-tolerant, which is a desirable property in the face of attacks. For example, even if some bits are flipped due to a fault (which may be induced by an attack), the overall computation may still provide at least an approximately correct result. This fault tolerance enhances resilience and robustness of AI systems against attacks.

Turning to efficient hardware utilization: SC can perform complex computations using relatively simple hardware, as SC may use basic logic gates to perform arithmetic operations. Accordingly, this efficient utilization of hardware resources may improve feasibility of deploying AIS capabilities on edge devices, extending protection to the increasingly important edge computing domain.

Turning to parallel processing: SC may naturally support parallel processing, which aligns well with a distributed nature of many AI applications. Accordingly, implementing SC may enhance speed and efficiency of AIS functions, allowing the AIS to quickly respond to threats.

Turning to noise resilience: unlike other types of computing in which noise (e.g., unwanted random variations) may be generally undesirable, for SC, noise can be integrated into the computations. Through this characteristic, implementing SC into AIS may help the AIS to maintain performance even in noisy environments, which are often encountered in real-world applications.

Advantageously, applying SC into the AIS of the systems, the methods, the computer-readable media, and the techniques disclosed herein introduces a level of randomness and fault tolerance that makes AI systems harder to exploit, increasing the overall robustness of the system. Furthermore, the efficient and parallel nature of SC ensures that AIS can be integrated into diverse AI applications without significantly increasing resource utilization.

### Examples of Noise Based Computation

Through applying SC, the systems, the methods, the computer-readable media, and the techniques disclosed herein may develop noise based computation (NBC). NBC may implement two classes of technologies, techniques to enable secure computation and threat detection for AIS, and techniques to authenticate data to control which data are used.

NBC may be applied to healthcare images, as an example. In such example, AI may train on patient images (e.g., public or private data sets trained the AI on recognizing whether the cell from a colon cancer pathology image is cancer or not cancer). In such example, the AI may be hosted on the cloud (e.g., as a computation service method). In such cases, any client who wants to know if a new image contains a cancer cell or not may do the following: (A) generating random images (e.g., 1,000, 5,000, 10,000, etc.) using, e.g., client facing code to generate the random images; (B) sending the random images (e.g., generally snow like noise images to AI in the cloud); (C) labeling images as ‘cancer’ or ‘not cancer’ using AI; (D) returning the labeled images to software at the client side; and (E) reviewing, calculating, and confirming, the most matched images to the original image and generating a predicted outcome of ‘cancer’ or ‘not cancer.’

In another example application, NBC may use MNIST data to recognize handwriting digits (10 possible outcomes). The accuracy may be 90+% and computation time may be about 800 microseconds, vs. minutes in FHE.

In some cases, NBC may be used by the systems, the methods, the computer-readable media, and the techniques disclosed herein for secure communication as, for example, a one-time key or stored for future uses. In some cases, performing secure communication (e.g., point-to-point, one-to-many, etc.) via NBC may include: (A) communicating parties each having a device that includes NBC-trained AI models (e.g., the trained AI models may be configured to recognize the alphabet, digits, special characters, specific images, etc.); (B) each AI model processing data (e.g., 100,000 random images (white noises)) and labeling the data based on the trained model outcomes; (C) the communicating party sending a labeled random datapoint to the receiving party (e.g., character ‘A’); (D) the NBC software identifying the random datapoint (e.g., identifying the character as ‘A’); (E) the communicating party continues sending random ‘noise’ data (e.g., images) to the receiving party until the message to be delivered is completed. In some cases, operations (A)-(E) can be repeated every time a new message is to be sent, thus, ensuring never sending the same ‘noise data’ (e.g., image) to the receiving party. However, in some cases, operations (A)-(E) may not be repeated every time a new message is to be sent. For example, operations (A)-(E) may, in some cases, be repeated every X times. X may, for example, be decided by communicating parties (e.g., collectively). X may, for example, be decided ahead of time (e.g., prior to sending a first message).

Advantageously, using the systems, the methods, the computer-readable media, and the techniques disclosed herein implementing NBC, the client may not have to send images outside of their network so that the images cannot be hacked or tampered with in transit or during calculation. In some cases, images may be chopped up to tiny noises and sent to an AI model to be perform inferences on the noises. In some cases, inferences may be added up at the client side to provide an outcome.

### Examples of Data Lineage Maintenance Techniques

The systems, the methods, the computer-readable media, and the techniques disclosed herein may maintain data lineage to help ensure the integrity of AI systems. Techniques for maintaining data lineage may include steganography, the practice of concealing information within another message or physical object to avoid detection. Steganography may be used to hide many different types of digital content, including text data, image data, video data, audio data, etc. The concealed information may be extracted later at a destination.

In some cases, content concealed through steganography may be encrypted (or processed in some way to make it harder to detect) before being hidden within another file format. Steganography may include concealing information in a way that avoids suspicion. Generally, steganography techniques may include text steganography (e.g., hiding information inside text files, such as by changing the format of existing text, changing words within a text, using context-free grammars to generate readable texts, generating random character sequences, etc.), image steganography (e.g., hiding information within image files, such as by using images to conceal information), video steganography (e.g., hiding information within video files, which may enable hiding large amounts of data within a moving stream of images and sounds, such as by embedding data in uncompressed raw video and then compressing it later, embedding data directly into the compressed data stream, etc.), audio steganography (e.g., hiding information within audio files, such as by embedding secret messages into an audio signal which alters the binary sequence of the corresponding audio file), network steganography (e.g., hiding information by embedding the information within network control protocols used in data transmission, such as TCP, UDP, ICMP, etc.), etc.

One specific technique of steganography is called least significant bit (LSB) steganography. LSB steganography may include embedding secret information in the least significant bits of a media file. For example, in an image file, each pixel is made up of three bytes of data corresponding to the colors red, green, and blue, and some image formats allocate an additional fourth byte to transparency, or alpha. In such cases, LSB steganography may alter the last bit of each of those fourth bytes to hide one bit of data. Modifying the last bit of the pixel value may not result in a visually perceptible change to the picture, which means that anyone viewing the original and the steganographically-modified images may not be able to tell the difference. Similar techniques can be applied to other digital media, such as audio and video, where data is hidden in parts of the file that result in the least change to the audible or visual output.

Another specific steganography technique may be the use of word or letter substitution. This may include techniques where the sender of a secret message conceals text of the secret message by distributing the text inside a much larger text, placing the words at specific intervals.

Another specific steganography technique may include hiding an entire partition on a hard drive or embedding data in the header section of files and network packets. The effectiveness of these techniques may depend on how much data they can hide and how easy they are to detect.

While steganography may be used maliciously (e.g., concealing malicious payloads in digital media files, ransomware and data exfiltration, hiding commands in webpages, malware, malvertising, e-commerce skimming, malicious software updates, document infection, etc.), steganography also has application in improving security for AI systems such as via sending and receiving highly sensitive information (e.g., without attracting attention) or digital watermarking that may be used to track if files are used without authorization.

A digital watermark may be a marker covertly embedded in a noise-tolerant signal such as audio, video or image data. Digital watermarks may be used to identify ownership of such signal. Watermarking may be the process of hiding digital information in a carrier signal; the hidden information may, in some cases, have a relation to the carrier signal. In some cases, digital watermarks may be used to verify the authenticity or integrity of the carrier signal or to show the identity of its owners. Like traditional physical watermarks, digital watermarks may be perceptible under certain conditions, e.g., after using some algorithm. For example, if a digital watermark distorts the carrier signal in a way that the digital watermark becomes easily perceivable, the digital watermark may be considered less effective, depending on its purpose. In digital watermarking, the signal may be audio, pictures, video, texts, 3D models, etc. A signal may carry several different watermarks at the same time. Unlike metadata that is added to the carrier signal, a digital watermark may not change the size of the carrier signal. The properties of a digital watermark may depend on the use case in which it is applied. For example, when marking media files with copyright information, a digital watermark may be robust against modifications that can be applied to the carrier signal. Instead, if integrity has to be ensured, a fragile watermark may be applied. Since a digital copy of data may be the same as the original, digital watermarking is a passive protection tool. As in, digital watermarking marks data, but may not degrade the data or control access to the data. Another application of digital watermarking is source tracking, where a watermark is embedded into a digital signal at each point of distribution such that if a copy of the data is found later, then the watermark may be retrieved from the copy and the source of the distribution is known. Both steganography and digital watermarking may employ steganographic techniques to embed data covertly in noisy signals.

In some cases, the systems, the methods, the computer-readable media, and the techniques disclosed herein may implement steganography to conceal information within other data to ensure confidentiality and integrity of the information. For example, the AIS of the systems, the methods, the computer-readable media, and the techniques may employ steganography techniques to embed and extract digital signatures or metadata within AI models or data sets. This enables the verification of data authenticity and helps ensure that the AI system is working with trusted and untampered data.

In some cases, the systems, the methods, the computer-readable media, and the techniques disclosed herein may implement watermark ledgers to serve as immutable records that track the history and lineage of data. The AIS of the systems, the methods, the computer-readable media, and the techniques disclosed herein may leverage blockchain or distributed ledger technologies to maintain watermarked records of data, capturing information about origin of the data, transformations of the data, access history of the data, etc. Accordingly, this may enable comprehensive data lineage tracking, allowing system administrators and auditors to verify the authenticity, integrity, and compliance of an AI system.

By combining steganography and watermark ledgers, the AIS of the systems, the methods, the computer-readable media, and the techniques disclosed herein may robustly accomplish provenance tracking. In some cases, each data element, model, or decision produced by an AI system can be traced back to its origin, ensuring accountability and facilitating the identification of potential malicious activities or data breaches.

Furthermore, in some cases, the watermark ledgers may provide a tamper-evident record of data and model changes. Any unauthorized modifications or tampering attempts may be detected through the consistency checks provided by the watermarking techniques. This ensures auditability, allowing for the investigation of suspicious activities and ensuring the transparency of an AI system's operations.

In some cases, steganography is used to embed watermarks, a form of covert and often indiscernible identifiers, directly into datasets. This combination allows for the protection of data from unauthorized usage and manipulation, while also ensuring its traceability. Embedding watermarks using steganographic techniques amplifies the inherent protection capabilities of watermarks by making them harder to detect/remove without the exact knowledge of their placement. By marrying these techniques, the systems, the methods, the computer-readable media, and the techniques disclosed herein create an almost imperceptible layer of data security that bolsters the resilience of datasets against adversarial attacks, while also preserving data ownership and lineage. This technique facilitates safer data sharing, secure collaborative learning and enhanced trust in machine learning models. In some cases, after applying watermarking, the systems, the methods, the computer-readable media, and the techniques disclosed herein may secure the integrity of the AI computations themselves using FHE. Once authenticated data is encrypted with a quantum safe FHE scheme, it will not need to be decrypted in order to have analysis (e.g., computations) performed. In some cases, lastly, at the beginning and the end of secure AI computations, the steganographic-watermarking allows a receiving party to check the authenticity of received data. If along the way, the information was somehow tampered with, the watermark may no longer be valid. Thus, the data would not be used for AI training or inferencing purposes, ensuring a trusted and secure AI. This end-to-end protection capability provides maximum protection of information.

Advantageously, the integration of steganography and watermark ledgers into the AIS of the systems, the methods, the computer-readable media, and the techniques disclosed herein enhances ability to establish and maintain data lineage, detect tampering, and provide an auditable trail of data transformations. This robust data governance approach may strengthen trust in AI system's decision-making processes, improve transparency, and enable regulatory compliance.

### Examples of Universal Multiplex Encoding

In some cases, watermarks implemented by the systems, the methods, the computer-readable media, and the techniques disclosed herein may include universal multiplex watermarks (UMW), which are one example of universal multiplexed encoding (UME). Unlike other techniques for communication across data formats, UME can steganographically embed machine-readable language within human-readable data streams, covering a spectrum of data types including text, images, video, audio, medical data, etc. Consequently, UME may serve as a key facilitator for a wide array of multiplexed human-machine communication possibilities. UME serves the purpose of seamlessly and securely amalgamating human and machine communication via intricately integrating machine-encoded data within human-readable content, consequently unveiling a multitude of potential applications across diverse sectors.

Generally, UME represents a pioneering technology that offers a unique capacity to steganographically integrate machine-readable language within data streams intended for human consumption. This technique may result in ‘multiplexed’ data carrying a dual-encoded message: an outer layer of content interpretable by humans and a concealed layer intended for machine interpretation. The systems, the methods, the computer-readable media, and the techniques disclosed herein employ a sophisticated set of encoding schemes to nest machine-readable data within human-intended content. This embedded data can be interlaced at multiple levels within diverse forms of content, such as text, images, audio, or video, and later decoded by AI systems employing corresponding decoding schemes.

As a foundational medium of human communication, text provides a pivotal platform for UME. By integrating machine-readable language within human-readable text, UME significantly enhances the security and effectiveness of text-based communication. For example, UME's text-based application may include the steganographic incorporation of machine-encoded data within written content. This technique may utilize a range of encoding algorithms to embed the machine-readable data at different hierarchical levels within the text, from characters and words to sentences. Upon receipt, AI systems can decode and interpret this embedded data using complementary decoding algorithms.

The implementation of UME within text that introduces a new era of secure, efficient, and multiplexed communication presents several benefits. With respect to secure communication, UME serves as a robust security layer in digital communication. By concealing critical information within seemingly ordinary text, UME significantly enhances the privacy and security of sensitive data transmissions. The implementation of UME can also safeguard digital content by enabling the integration of copyright information within the text, thereby deterring unauthorized use and distribution, providing effective digital rights management. Furthermore, the implementation of UME provides the unique ability to embed relevant metadata within the text, thus providing additional context or background information without complicating the human-readable content. Such metadata can serve various purposes including content categorization, search optimization, and data analytics.

It should be understood that the application of UME by the systems, the methods, the computer-readable media, and the techniques disclosed herein extends beyond text. For example, UME's utility in embedding metadata or concealed information within images and videos can serve diverse purposes, ranging from secure communication, digital forensics, digital rights management, to creating augmented reality experiences. In another example, for audio data, UME may be applied to embed additional information can assist AI systems in comprehending the context or source of the audio. This proves invaluable in applications such as voice recognition, audio forensics, and telecommunication. In another example, for medical data, UME may be applied to revolutionize the medical sector by facilitating the embedding of patient data, medical instructions, or diagnostic data within medical images or texts without interfering with the original data. This significantly enhances patient data management, telemedicine, and medical research.

Advantageously, UME may be applied by the systems, the methods, the computer-readable media, and the techniques disclosed herein to integrate machine-readable data within diverse human-intended data stream, thereby providing the potential to revolutionize human-machine communication across a wide range of applications within digital communications.

### Implementation of Universal Multiplex Watermarks

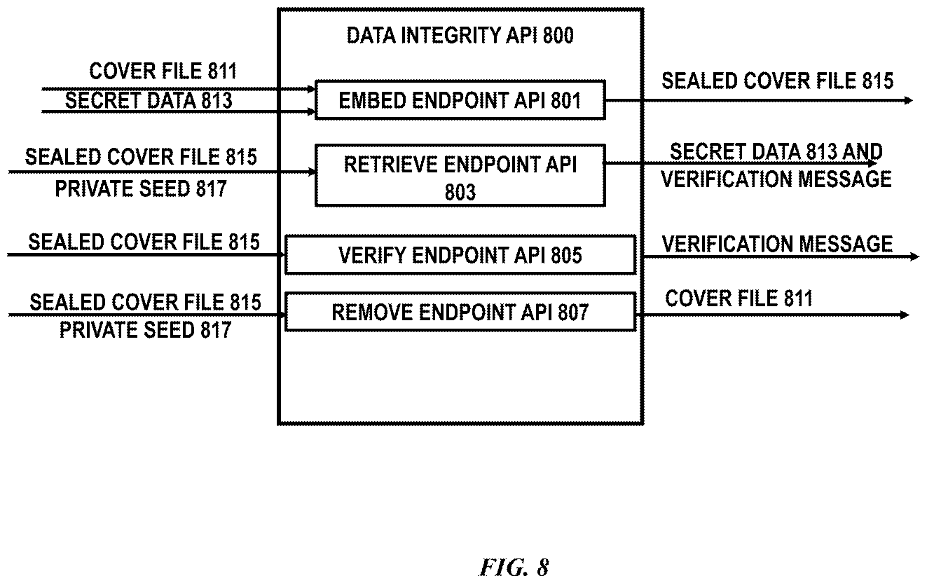

In some embodiments, the present disclosure provides an Application Programming Interface (API) or a comprehensive platform for secure data operations. The API may provide a combination of encryption, digital signatures, hashing, steganography, and blockchain technology which beneficially allows for a versatile and robust solution for data security and provenance, non-repudiation and lineage checking as described above. FIG. 8 schematically shows an example of a data integrity API 800 implementing the methods herein. In some embodiments, the data integrity API 800 allows for the embedding of a secret file into a cover file thereby creating a seal. The secret file can be of any type. The API may be a standard or unified API that can support any standard file format.

In some cases, the data integrity API 800 may comprise a Universal Steganographic Watermarking API. The data integrity API 800 may be a unified API architecture that seamlessly watermarks diverse file types (e.g., text file, image file, video file, audio file, HTML, etc.). The data integrity API 800 may provide a plurality of functions including, but not limited to, conceal, reveal, and check. Each function is designed to ensure robust security and integrity of the watermarking process.

As shown in FIG. 8, the data integrity API 800 may comprise a conceal API or an embed endpoint API 801. The embed endpoint takes as input a cover file 811 and a secret file 813 and embeds the secret file, using proprietary technologies to output a sealed cover file 815. The output sealed covered file may be the embedded cover file with a seal. As described above, the cover file and/or the secret file (file that contains the secret data) can be of any type (e.g., audios, videos, images, plaintext files, etc.). A cover file may be any file that is to be sealed/watermarked. A secret file may be any file that contains secret data to be embedded in the cover file. In some cases, the cover file may be visible to human whereas the secret data may only be machine-readable. For instance, the cover file may be a medical image (e.g., patient chest x-rays as the cover file, that embedded a QR code with patient information for lung diagnostic i.e., secret data). The cover file/secret file may be static or dynamic (e.g. streaming data).

In some cases, the embed endpoint API 801embeds a secret data 813 within a cover file 811 by executing the following operations:
1. Initial Encoding: a) The cover file is read into memory and encoded into an array using an encoding scheme. In some cases, the encoding scheme may be adaptively selected based on the file type of the cover file; b) The secret file is read into memory and encoded into an array using an encoding scheme. In some cases, the encoding scheme may be selected to ensure compatibility and ease of handling. As an example, the encoded cover file may be a base64 string encoding of the cover file, and the secret file may be encoded into a base64 string encoding of the secret file.
2. Secret Packaging: The encoded secret file is standardized in a format for subsequent processing (e.g., scrambling). For example, the name (file format) of the encoded file is ensured to include an extension such as a JSON response “Secret file name: string name of the secret file, must include extension.”
3. Scrambling: A secure pseudorandom number generator (PRNG), seeded with a proprietary value, is used to scramble the encoded secret data to provide a crucial layer of obfuscation, protecting the secret against unauthorized detection and extraction. The secret file may contain secret information to be hidden behind a cover file (e.g., patient information hidden behind a chest X ray). The ‘seed’ may be selected by a user and used to with a PRNG method for scrambling purpose. As an example, the seed may be a private seed comprising a string that protects the secret data. The string may be selected and/or defined by a user (e.g., a uuid4 string). For instance, the user selected seed may be combined with the pseudorandom number generated by a PRNG which is used to scramble and unscramble the encoded secret file.
4. Compression: The scrambled secret data is compressed minimizing its impact on the cover file and maintaining the cover file's usability and inconspicuousness. The compressed secret data is then inserted into the encoded cover file. The compression beneficially reduces the overall impact on the file size of the cover file.
5. Signature Generation: A cryptographic of the compressed and scrambled secret data is computed. The cryptographic signature of the secret data may act as a unique signature or fingerprint of the secret data, allowing for tamper detection and integrity verification. The scrambled and compressed secret data may be hashed to generate a specific hash key for the embedded file. The hash is a cryptographic signature of the secret data.
6. Final Assembly: a) The generated cryptographic signature is added to the compressed data. For instance, the hash may be appended to the compressed file. b) The data (the appended signature (hash) and the compressed data) is then embedded into the cover file at a specific offset. The specific offset may be determined based on the file type and/or intended invisibility of the watermark. For example, the offset may be determined by examining different byte locations in the cover file, and a location is determined based on the file types (audio, video, image, plaintext etc, etc.). In some cases, the system herein may utilize machine learning algorithms to analyze the content of the cover file such as digital media (e.g., images, videos, audio) and determine the most suitable watermarking locations/offset based on the content characteristics and intended use case.
7. File Output: a) The modified data, now containing the embedded secret, is written out to a new file 815 of the same type as the original cover file. b) This outputted file is the watermarked carrier, ready for distribution or storage. For example, the output may be a JSON response including the sealed file and extension.

Following is an example of input and output to the embed endpoint API

### Input:

Cover file: base64 string encoding of the cover file.
Cover file name: string name of the cover file, must include extension.
Secret file format: base64 string encoding of the secret file.
Secret file name: string name of the secret file, must include extension.
Private Seed: a string that protects the seal, user selected and defined (e.g., a uuid4 string)

### Output:

A JSON response of the following format:

```
{
“result”: {
    “sealed_file”: str base64,
    “extension”: str extension of ‘sealed_file’
  }
}
```

In some embodiments, the data integrity API may further comprise a Reveal API or retrieve endpoint API 803. The Reveal API 803 extracts the secret data from a watermarked file by inverting the steps of the Conceal API 801. As an example, the retrieve endpoint API 803 may perform the following operations:
1. Extraction: a) The watermarked file or sealed cover file 815 is read into memory and decoded by the retrieve endpoint API 803. b) The retrieve endpoint API 803 scans the data for the specific sequences that denotes the watermark. c) The embedded data based on the specific sequences, containing the compressed data and cryptographic signature, is extracted.
2. Decompression: a) The compressed data is decompressed using the same algorithm used in the compression step. b) The result is the recovery of the scrambled data.
3. Unscrambling and Decoding: a) The scrambled data is unscrambled with the same pseudorandom byte sequence used in the scrambling step. b) The unscrambling operation recovers the original data with encoded secret data. c) The data is decoded into the actual secret file using the inverse of the encoding scheme used in the conceal API.

In some cases, the retrieve endpoint API takes the sealed file 815 and the private seed 817 used to create the sealed file, to reveal the embedded secret data. In some cases, the retrieve endpoint API may also run a verification check, and output a notification indicating whether the cover file or the secret file has been tampered with. Following is an example of input and output to the retrieve endpoint API:

### Input:

Sealed file: base64 string encoding of the sealed file.
Sealed file extension: string of the sealed file name, must include extension.
Private seed: a string that was used to protect the seal, user selected and defined (we recommend a uuid4 string)

### Output:

A JSON response of the following format:

```
{
    “result”: {
        “secret”: str base64 of secret file,
        “extension”: str extension of ‘secret’
      },
    “verification_result” : str notifies if tampering occurred
  }
```

In some embodiments, the data integrity API may further comprise a verify endpoint API 805. The verify endpoint API allows for efficient verification of the integrity and authenticity of a watermarked file without the need to fully extract and reveal the secret data. For instance, the verify endpoint takes the sealed file and verifies the status of the seal to determine if the seal has been broken. If the seal is broken the verify endpoint API may run a verification check, to output a notification indicating whether the cover file or the secret file has been tampered with.

The verify endpoint API may perform the following operations:
1. Extraction: a) The watermarked file is read and decoded. b) The embedded compressed data and signature are extracted in a process similar to the operation in the Reveal API.
2. Signature Verification: a) The compressed data is hashed using the same cryptographic hash function used in the signature generation step of the Conceal API. b) This newly computed hash is compared with the signature extracted from the watermarked file. c) If the two hashes match, it confirms that the watermarked data has not been altered since the watermark was applied, verifying its integrity and authenticity. Following is an example of the input and output of the verify endpoint API:

### Input:

a. Sealed file: base64 string encoding of the sealed file.
b. Sealed file extension: string of the sealed file name, must include extension.

### Output:

a. A JSON response of the following format:

```
{
  “result”: {
      “status”: str tampered ∥ clean,
      “message”: str explication of status (if
        tampered, which: cover or seal)
    }
}
```

In some embodiments, the data integrity API may further comprise a remove endpoint API 807. The remove endpoint API takes the sealed file and removes the seal, restores the cover file to its original state. Following is an example of the input and output to the remove endpoint API:

### Input:

Sealed file: base64 string encoding of the sealed file.
Sealed file extension: string of the sealed file name, must include extension.
Private seed: a string that was used to protect the seal, user selected and defined (we recommend a uuid4 string)

### Output:

A JSON response of the following format:

```
{
  “result”: {
      “cover_file”: str base64 of cover file,
      “extension” : str extension of ‘cover_file’
    }
}
```

The above-mentioned APIs and methods provide a Universal Steganographic Watermarking API employing a multi-layered security model to prevent tampering and ensure the integrity of the watermarked data. The multi-layered security model may comprise the proprietary seed value, the unique order of operations (e.g., scrambling, compression, and hashing), and the inclusion of a cryptographic signature.

As described above, The PRNG used in the scrambling and unscrambling steps is seeded with a proprietary value known only to authorized parties/users. The private seed acts as a secret key, ensuring that only users with knowledge of the correct seed can successfully unscramble and extract the watermarked data. In some cases, attempts to tamper with the watermarked file or extract the secret without the correct seed can result in garbage data after unscrambling, rendering the tampered data useless. The private seed value may be a key generated by the system herein and distributed to the authorized user(s).

The unique sequence of scrambling, compression, and hashing adds additional security layer in preventing tampering. For instance, scrambling the data before compression obfuscates the original content, making it difficult for an attacker to discern patterns or make targeted modifications. Compressing the scrambled data further obscures its structure and reduces the potential for tampering by minimizing redundancy and predictability. Hashing the compressed, scrambled data creates a unique signature that is sensitive to any changes in the preceding steps.

The signature-based Integrity Verification performed by the verify endpoint API adds another layer of security. The signature generated by hashing the compressed, scrambled data serves as a tamper-evident seal. Any modifications to the watermarked data, whether in the compressed or scrambled form can result in a different hash value when recomputed during the Check API's signature verification process. A mismatch between the recomputed hash and the extracted signature conclusively indicates that the watermarked data has been tampered with, allowing the verify endpoint API to detect and flag any unauthorized alterations.

The combination of the above APIs creates a robust barrier against tampering attempts. It requires an entity to possess the correct proprietary seed value to unscramble the data, reverse the compression algorithm to restore the original scrambled data, and then make modifications that preserve the exact same hash value when re-scrambled and re-compressed. The computational infeasibility of finding such a collision in the cryptographic hash function, coupled with the need for the secret seed, makes tampering practically impossible without detection.

The inclusion of the signature as a separate component in the watermarked data provides an additional layer of protection. Even if an attacker manages to modify the compressed, scrambled data while preserving the hash value, they also need to update the signature accordingly. Without knowledge of the secret seed and the specific hashing algorithm used, generating a valid signature for the tampered data becomes an insurmountable challenge.

The Universal Steganographic Watermarking API's security model, built upon the proprietary seed, precise order of operations, and signature-based integrity verification, offers an improved defense against tampering. The interlocking nature of these security measures ensures that any unauthorized modifications to the watermarked data may be detected, maintaining the integrity and authenticity of the embedded secret information.

The Universal Steganographic Watermarking API, which comprises the Conceal, Reveal, and Verify functions, provides a versatile and secure solution for watermarking diverse file types. By employing strong encryption primitives, compression, and obfuscation techniques, along with a robust integrity verification mechanism, the API ensures that secret data can be imperceptibly and securely embedded into a wide range of carrier files.

The order of scrambling before compression enhances security by making it more difficult for an attacker to guess the content of the secret data based on patterns in the compressed output. The Verify API allows for efficient integrity verification without the need to fully extract and reveal the secret, improving performance in scenarios where only authenticity needs to be confirmed.

The multi-layered security model, incorporating a proprietary seed value, optimal order of operations, and signature-based integrity verification, creates a barrier against tampering attempts. The interlocking nature of these security measures ensures that any unauthorized modifications to the watermarked data will be detected, maintaining the integrity and authenticity of the embedded secret information.

With its unified architecture, optimized algorithms, and comprehensive security model, the Universal Steganographic Watermarking API provides improvement in the field of digital watermarking. It upholds the fundamental principles of steganography while addressing the challenges faced by the current fragmented approach, providing a reliable and secure solution for concealing and protecting sensitive data within digital media.

In some embodiments, the data integrity API may comprise other endpoint APIs. For instance, the data integrity API may comprise encrypt endpoint API, decrypt endpoint API, varieties of hashing APIs for hashing different types of files (e.g., text, image, video, etc.). As described elsewhere herein, the system may be capable of adaptively selecting an API based on a content and/or type of the file.

In some cases, the encryption API endpoints may be used for the encryption and decryption of files using a suitable encryption algorithm (e.g., AES256 encryption). For example, the encrypt endpoint encrypts files using the Advanced Encryption Standard (AES) with a 256-bit key in Galois/Counter Mode (GCM). For instance, the encryption API endpoint may take as input a binary file. As an example, the response may be a downloadable.bin file that also includes the encoded filename for reference. Following is an example of the input and output of the encryption API endpoint:

### Input

File: A file uploaded via multi-part form data.

### Output

The endpoint generates a.bin file containing the encrypted file content, the encrypted DEK, nonce, and encryption tag. The filename is also encoded within this file. In some cases, the decrypt API endpoint provides functionality for decrypting files that were previously encrypted by the encryption API endpoint (e.g., using AES-256 GCM encryption). This endpoint can provide the decryption of a variety of encrypted content such as the Data Encryption Key (DEK), nonce, and encrypted content extracted from an uploaded.bin file. In some cases, the original filename is also retrieved from the encrypted file and used in the downloadable response that contains the decrypted file content. Following is an example of the input and output of the decryption API endpoint:

### Input:

An encrypted file: A encrypted file uploaded via multi-part form data (.bin)

### Output:

Upon successful decryption, the endpoint returns a downloadable file that contains the decrypted content. The original filename is preserved and used in the response.

In some embodiments, the system may provide a variety of hashing APIs for hashing different types of files. For example, API endpoints for hashing an Image or Text may allow for the generation of an SHA256 Hash of an image or text file. In another example, API endpoints for hashing image is tailored for generating SHA-256 hashes of image files. This service supports all image formats including PNG, JPEG, and DICOM and various others types. The endpoint analyzes the uploaded image's MIME type to ensure compatibility, and upon validation, computes and returns the hash of the image content. Following is an example of the input and output of the hash API:

### Input:

a. The image file to be hashed.

### Output:

a. The output is a JSON response of the following format:

{
“hash”: str SHA256 hash of uploaded image
}

A hash text endpoint is provided for generating SHA-256 hashes of text-based documents, including PDF and Microsoft Excel files. This service evaluates the MIME type of the uploaded document to confirm its eligibility. If the document's format is supported, the endpoint computes its SHA-256 hash and returns the hash value. Following is an example of the input and output of the text hash API:

### Input:

The document file to be hashed.

### Output:

The output is a JSON of the following format:

{
“hash”: str SHA256 hash of uploaded text
}

### Privacy-Enhanced Adaptive Digital Watermarking System (PEADWS)

In another aspect, a Privacy-Enhanced Adaptive Digital Watermarking System (PEADWS) is provided to address the challenges of data privacy, security, and integrity in digital media, leveraging blockchain technology, advanced encryption standards, and machine learning algorithms. The system dynamically adapts its watermarking technique based on the content type, intended security level, and regulatory compliance requirements, ensuring optimal balance between robustness, imperceptibility, and computational efficiency.

The digital watermarking system may integrate Blockchain for Watermark Management. For example, the digital watermarking system herein may use blockchain technology for creating a decentralized, secure, and transparent registry for watermarks. In some embodiments, the digital watermarking system may provide Content-Aware Adaptive Watermarking. For example, the digital watermarking system may utilize machine learning to analyze cover file content (e.g., media content) and adaptively select watermarking and encryption techniques based on the content characteristics and security requirements. In some embodiments, the digital watermarking system may comprise a Regulatory Compliance Automation. Automating the compliance of watermarking processes with international data protection laws through an integrated tool is a unique feature that addresses a significant need in the digital content industry. In some embodiments, the digital watermarking system provides Dynamic Adaptation of Encryption and Watermarking Parameters. The system may dynamically adjust encryption and watermarking parameters in real-time, based on the analysis of content and regulatory requirements, thereby balancing security, privacy, and performance.

In some embodiments, the digital watermarking system may comprise a Content-Aware Watermarking Engine. The watermarking engine can be implemented using the data integrity APIs as described above with additional capability to adapt to different cover file content. For instance, the Content-Aware Watermarking Engine may utilize machine learning algorithms to analyze the content of digital media (e.g., images, videos, audio) and determine a watermarking technique based on the content characteristics and intended use case. In some embodiments, the machine learning model may be a transformer model or large language model (LLM) that takes as input the file to be watermarked/sealed (e.g., image) and outputs a specific API or algorithm to watermark/seal this input data.

In some embodiments, the digital watermarking system may comprise a Blockchain-Based Watermark Registry for managing watermarks. For example, the system may implement a decentralized registry for watermarks on a blockchain, ensuring tamper-proof storage, traceability, and verification of watermarked content. This blockchain registry facilitates the management of digital rights and aids in the detection and prevention of unauthorized use.

In some embodiments, the digital watermarking system may comprise an Adaptive Encryption Module. The Adaptive Encryption Module Leverages advanced encryption standards (AES) and public key infrastructure (PKI) to encrypt watermark information. In some embodiments, the encryption scheme is adaptively selected based on the sensitivity of the watermark content and the required level of security. The selection may be based on handcrafted selection rules or machine learning algorithm trained model.

In some embodiments, the digital watermarking system may be integrated with a Regulatory Compliance Analyzer. The Regulatory Compliance Analyzer may be a compliance analysis tool that automatically assesses and ensures that the watermarking process adheres to global data protection regulations (e.g., GDPR, CCPA) based on the geographical location and nature of the data. For example, the input to the Regulatory Compliance Analyzer may comprise the original file/data, location where the request to watermark the data comes from, and the rules that apply to that location. In some cases, the compliance tools may be provided by a third-party and the digital watermarking system herein provides an integration point to interface with the compliance tool. For example, the digital watermarking system may make an API call to assess the data and/or information about data such as location of the data, rules of the location, and other rules apply to specific kind of data (e.g., electronic medical records) to determined how to handle the compliance of this data (e.g., can't store this new watermarked data outside of EU to comply with GDPR).

In some embodiments, the digital watermarking system may comprise a Dynamic Watermark Embedding and Extraction feature. For instance, the system may employ an embedding algorithm that dynamically adjusts watermark strength and depth based on one or more media content's perceptual features and the encryption module's output, optimizing for both robustness and imperceptibility. The system may dynamically adjust encryption strength (e.g., encryption strength, no encryption needed) and/or determine employing additional technologies (e.g., steganography, spread spectrum or replacing data with noise) based on the type of content. For example, audio and video allows spread spectrum types of embedding while plaintext may not (spread spectrum is a telecommunication technique that spreads a signal across a wider frequency band than the original signal's bandwidth). The extraction process uses a combination of cryptographic verification and machine learning-based anomaly detection to accurately retrieve and authenticate the watermark even in the presence of corruption or tampering. For example, models may be trained to determine a type of attacks based on the type of input data. The model may be trained on type of attacks on the watermarked/sealed data, and the type of ‘signature.’ Once trained, the model may be capable of determining the type of attacks in the future, and/or predicting, based on certain types of data, if and how the attack will likely to happen. In some cases, models may be trained to predict how the ‘seal’ is broken. If the prediction is a non-malicious reason for the broken seal, the system may be able to still retrieve the original ‘secret’ (the watermark) despite a broken seal.

### Examples of Methods

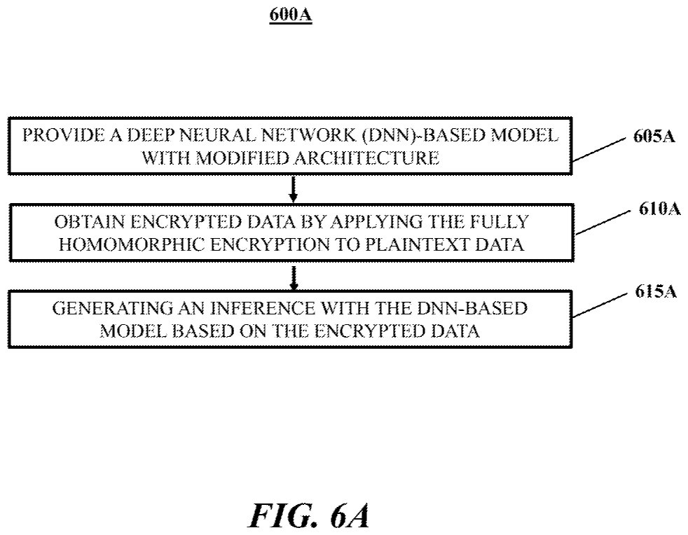

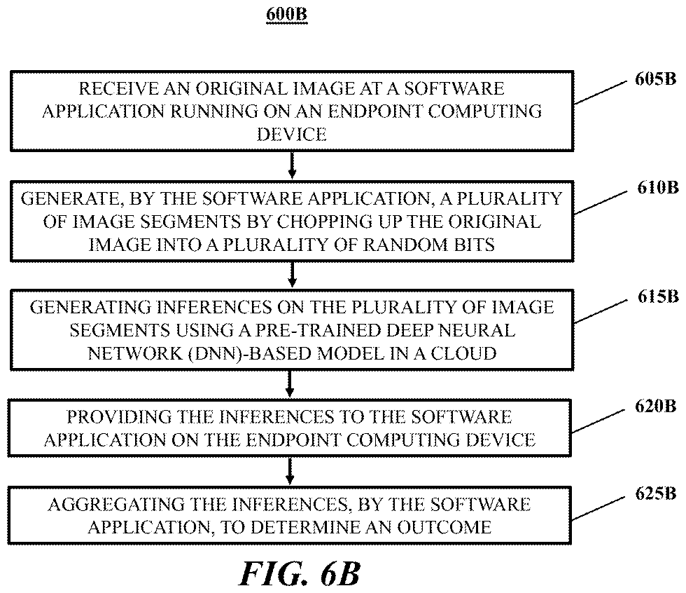

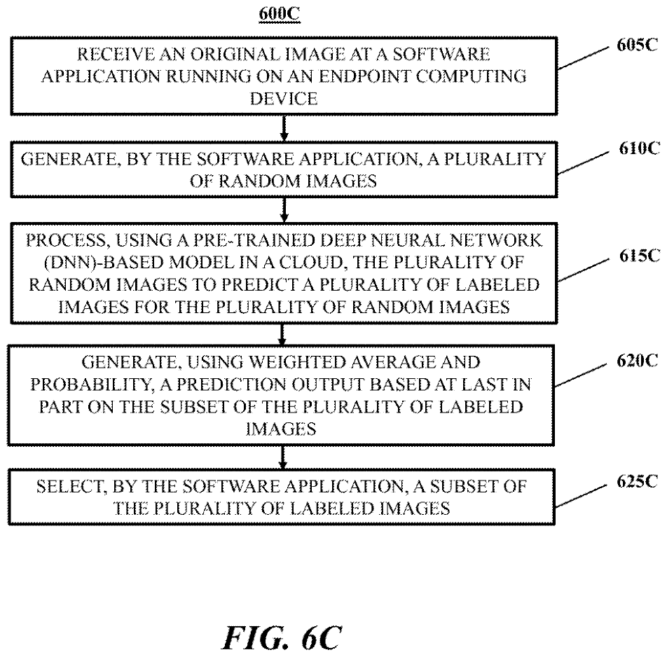

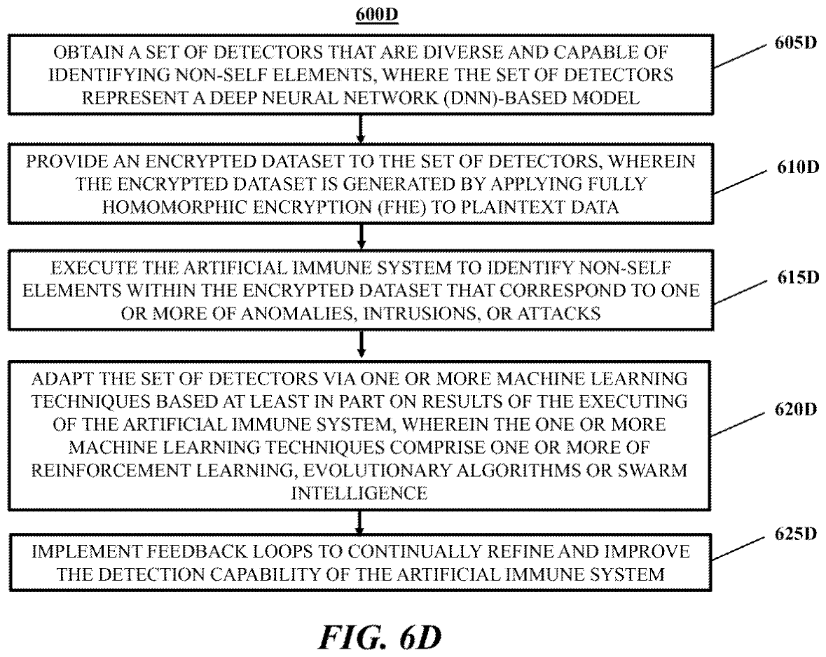

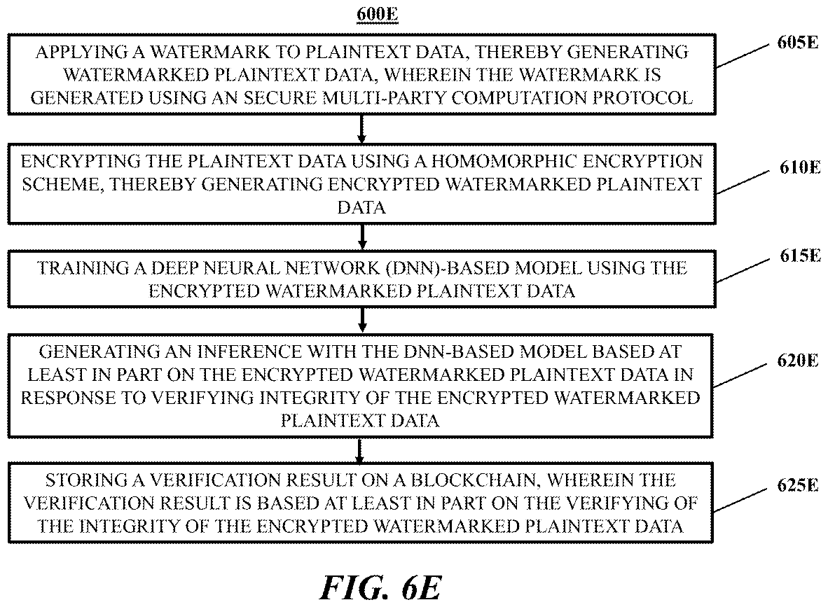

FIG. 6A shows an example of a flowchart illustrating a method 600A for providing trusted artificial intelligence using FHE. In some cases, the method 600A may comprise: providing a DNN-based model with modified architecture. In some cases, the modified architecture at least (i) uses a Gaussian function as an activation function and (ii) removes one or more pooling layers (block 605A); obtaining encrypted data, wherein the encrypted data are generated by applying the FHE to plaintext data (block 610A); and generating an inference with the DNN-based model based on the encrypted data (block 615A).

In some cases, the DNN-based model is trained on plaintext training data. In some cases, the DNN-based model is trained on encrypted training data. In some cases, the DNN-based model is pre-trained on plaintext training data and encrypted training data. In some cases, the method 600A further includes during a training phase to train the DNN-based model with the modified architecture, selecting values for one or more hyperparameters based at least in part on monitoring criticality. In some cases, the method 600A further includes identifying and testing FHE-appropriate approximations and alternatives for various nonlinear activation and loss functions. In some cases, the one or more hyperparameters include at least one of mean and variance of the random initialization distributions, batch size, learning rate, or optimizer settings. In some cases, a mean or variance of the Gaussian function is tuned during the training phase. In some cases, the encrypted data are generated using a homomorphic encryption scheme such that computation results generated on the encrypted data match computation results generated on the plaintext data. In some cases, the homomorphic encryption scheme includes CKKS or TFHE. In some cases, the DNN-based model is trained using adversarial machine learning techniques. In some cases, the adversarial machine learning techniques include proactively acquiring knowledge from machine learning systems under attack. In some cases, training the DNN-based model further includes adopting reinforcement learning and transfer learning. In some cases, the DNN-based model is trained to automatically monitor a cyberthreat or a cyberattack. In some cases, the cyberthreat includes one or more of data poison attacks, malicious Als, or malwares. In some cases, the DNN-based model is trained to detect an anomaly. In some cases, the DNN-based model is trained using collaborative learning. In some cases, the DNN-based model is trained by a plurality of computing nodes, wherein each computing node trains the DNN-based model using a set of training data not shared with other computing nodes. In some cases, the inference includes an anomaly detection output generated by a computing node. In some cases, the method 600A further includes aggregating a plurality of anomaly detection outputs from a plurality of computing nodes to generate an anomaly detection result. In some cases, each of the plurality of computing nodes generates an anomaly detection output based at least in part on a portion of distributed data. In some cases, the portion of distributed data include FHE-encrypted data. In some cases, the plurality of anomaly detection outputs are shared and stored using blockchain. In some cases, the plaintext data includes image data. In some cases, the method 600A further includes generating a hypervector based on the plaintext data to accelerate the computation. In some cases, the plaintext data is embedded with machine-readable data using one or more encoding algorithms. In some cases, the machine-readable data is embedded at different hierarchical levels. In some cases, the different hierarchical levels include character-level, word-level, and sentence-level of a textual input data. In some cases, the machine-readable data includes Universal Multiplex Watermarks used for document authentication and verification. In some cases, the Universal Multiplex Watermark contain metadata and encrypted identifying information of a data source or an owner of the plaintext data. In some cases, the Universal Multiplex Watermarks are undetectable to a human, and wherein the Universal Multiplex Watermarks are detectable and decodable by hardware or software. In some cases, the Universal Multiplex Watermarks are used for confirming the authenticity of the plaintext data and verifying a source and integrity of the plaintext data. In some cases, the FHE is applied to plaintext data after embedding the plaintext data with Universal Multiplex Watermarks. In some cases, the method 600A further includes decrypting the encrypted data and verifying an integrity of the decrypted data using a checksum. In some cases, one or more transactions associated with unique watermark identifier are used as a verification point for the unique watermark identifier, which serves as a checksum for the plaintext data. In some cases, the checksum is derived from the plaintext data prior to encryption and is stored on a blockchain for secure and tamper-resistant record keeping. In some cases, the checksums on the blockchain are used for investigation of unauthorized data alteration attempts. In some cases, the unauthorized data alteration attempts are detected by detecting a mismatch between the decrypted data and the recorded checksum. In some cases, the method 600A further includes generating an alert upon detection of the mismatch. In some cases, the alert automatically triggers an automatic mitigation process, including at least one of isolation of affected data, initiation of a security audit, or activation of data recovery measures from a verified backup. In some cases, the embedded machine-readable data represents a watermark functioning as a unique identifier for the plaintext data. In some cases, the unique identifier is encrypted using the FHE, enabling computations to be performed on the encrypted watermark without revealing content of the unique identifier. In some cases, the encrypted watermark is verified by applying one or more operations of the FHE that correspond to watermark verification steps, yielding an encrypted verification result. In some cases, the encrypted verification result is decrypted to (i) verify an authenticity of the plaintext data, and (ii) determine whether the plaintext data has been tampered with or replaced. In some cases, the unique watermark identifier is linked to a transaction on a blockchain, and wherein an immutable record of the unique watermark identifier, ownership of the plaintext data, and one or more associated transactions is recorded on the blockchain. In some cases, the one or more associated transactions are used as a verification point for the unique watermark identifier, which serves as a checksum for the plaintext data. In some cases, embedding the machine-readable data and encrypting the plaintext data are applied on multiple layers of data representation. In some cases, the multiple layers of data representation comprise a pixel level for images, frame level for videos, and packet level for network communications. In some cases, embedding the machine-readable data and encrypting the plaintext data employ one or more machine learning algorithms.

FIG. 6B shows an example of a flowchart illustrating a method 600B for providing trusted AI using stochastic computing. In some cases, the method 600B may include: receiving an original image at a software application running on an endpoint computing device (block 605B); generating, by the software application, a plurality of image segments by chopping up the original image into a plurality of random bits (block 610B); generating inferences on the plurality of image segments using a pre-trained DNN-based model in a cloud (block 615B); providing the inferences to the software application on the endpoint computing device (block 620B); and aggregating the inferences, by the software application, to determine an outcome (block 625B).

In some cases, an accuracy of the outcome is similar to that of an outcome obtained by generating an inference directly on the original image. For instance, an accuracy of an inference made based on the aggregated inferences of image segments may be within at least 1%, 2%, 3%, 4%, 5% accuracy range of an inference made based on the original image. In some cases, the inferences comprise a plurality of labels predicted for the plurality of image segments.

FIG. 6C shows an example of a flowchart illustrating a method 600C for providing trusted AI using NBC. In some cases, the method 600C may include: receiving an original image at a software application running on an endpoint computing device (block 605C); generating, by the software application, a plurality of random images (block 610C); processing, using a pre-trained DNN-based model in a cloud, the plurality of random images to predict a plurality of labeled images for the plurality of random images (block 615C); selecting, by the software application, a subset of the plurality of labeled images, wherein a number of images in the subset of the plurality of labeled images is set by the software application (block 620C); and generating, using weighted average and probability, a prediction output based at last in part on the subset of the plurality of labeled images (block 625C).

In some cases, the plurality of random images are generated by a random image generator of the software application.

FIG. 6D shows an example of a flowchart illustrating a method 600D for providing trusted AI using an artificial immune system. In some cases, the method 600D may include: obtaining a set of detectors that are diverse and capable of identifying non-self elements, where the set of detectors represent a DNN-based model (block 605D); providing an encrypted dataset to the set of detectors, wherein the encrypted dataset is generated by applying FHE to plaintext data (block 610D); executing the artificial immune system to identify non-self elements within the encrypted dataset that correspond to one or more of anomalies, intrusions, or attacks (block 615D); adapting the set of detectors via one or more machine learning techniques based at least in part on results of the executing of the artificial immune system, wherein the one or more machine learning techniques comprise one or more of reinforcement learning, evolutionary algorithms or swarm intelligence (block 620D); and implementing feedback loops to continually refine and improve the detection capability of the artificial immune system (block 625D).

FIG. 6E shows an example of a flowchart illustrating a method 600E for providing trusted AI with SMPC based at least in part on watermarking. In some cases, the method 600E may include: applying a watermark to plaintext data, thereby generating watermarked plaintext data, wherein the watermark is generated using an SMPC protocol (block 605E); encrypting the plaintext data using a homomorphic encryption scheme, thereby generating encrypted watermarked plaintext data (block 610E); training a DNN-based model using the encrypted watermarked plaintext data (block 615E); generating an inference with the DNN-based model based at least in part on the encrypted watermarked plaintext data in response to verifying integrity of the encrypted watermarked plaintext data (block 620E); storing a verification result on a blockchain, wherein the verification result is based at least in part on the verifying of the integrity of the encrypted watermarked plaintext data (block 625E).

In some cases, any number of operations of the one or more operations disclosed above with respect to one or more of methods 600A-600E may be added or removed. Further, the one or more operations disclosed above with respect to one or more of methods 600A-600E may be performed in any order. Further, at least one of the one or more operations disclosed above with respect to one or more of methods 600A-600E may be repeated, e.g., iteratively.

### Examples of Secure Integrated Circuits

Unlike other cybersecurity techniques that are reactive, addressing issues only after they have been detected (and, for example, may only defend against known threats and may be vulnerable to novel attacks), the systems, the methods, the computer-readable media, and the techniques disclosed herein may apply the convergence of secure integrated circuits, including Trusted Platform Modules (TPMs), Hardware Security Modules (HSMs), and Physical Unclonable Functions (PUFs) with the emerging field of AIS to augment system security in an ever-evolving threat landscape.

A TPM may be a dedicated microcontroller that may be used to secure hardware by integrating cryptographic keys into devices. TPMs may support a variety of functions, including remote attestation and sealed storage. An HSM is a secure cryptographic processor that may be used to provide substantial physical security measures to safeguard cryptographic keys and execute sensitive operations such as encryption and digital signing. A PUF implements inherent variations in hardware during manufacturing and may be used to create a unique ‘fingerprint’ for each device. This fingerprint can be used for secure identification and authentication. The integration of secure integrated circuits with AIS enables a new era of hardware security. For example, AIS can be used to monitor the behavior of hardware components continually. Any anomalies in the functioning of the TPMs, HSMs, or PUFs could be detected and mitigated immediately, enhancing the robustness of the system. PUFs, when integrated with AIS, can create a more secure and dynamic authentication process. AIS's learning mechanisms can continually update the authentication process based on observed patterns, making it more resilient to attacks. The ability of AIS to learn and adapt can ensure that hardware security remains robust in the face of evolving threats. By learning from past attacks, AIS can adapt its defense mechanisms to be more effective against future attacks.

The protective mechanisms offered by TPMs, HSMs, and PUFs can be combined with the adaptable, learning nature of AIS to provide comprehensive security. Through implementing these secure integrated circuits, AIS may accomplish tasks include anomaly detection, pattern recognition, learning, and distributed detection mechanisms, which enable systems to self-organize, learn from data, and make decisions about potential threats. AIS harnesses these capabilities to provide dynamic, adaptable security that can respond to emerging threats in real-time.

### Examples of Computing Systems

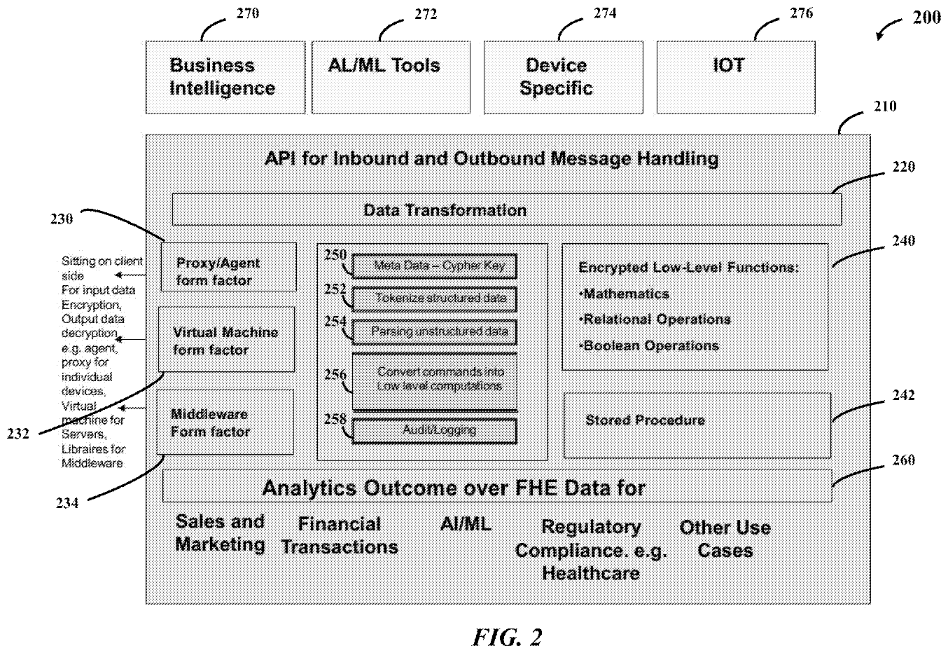

FIG. 2 shows an example architecture diagram 200 for an FHE-based trusted AI. As illustrated, an API for inbound and outbound message handling 210 may perform one or more of the methods or techniques disclosed herein. For example, the API 210 may be configured to perform data transformation (e.g., via homomorphic encryption) via a data transformation module 220.

Furthermore, the API 210 may include a proxy/agent form factor module 230 that is configured to provide client side proxy software to a computing device (e.g., a laptop, a desktop computer, a smaller device, such as a mobile phone, with agent software, etc.). The virtual machine form factor 232 may provide software provided in a server (e.g., a front bank of servers in a datacenter) serving as a communications gateway between an enterprise and the outside world. The middleware form facto 234 may provide a set of APIs that solution providers may use to integrate capabilities disclosed herein to solutions, thereby offering FHE to the solutions.

In some cases, an encrypted low-level functions module 240 may execute low-level functions, such as matrix addition/multiplication, binary shifts, and Boolean operations (AND, OR, NOR, etc.). A stored procedure module 242 may, instead of reworking individual computation, group computations. For example, the procedure module 242 may group matrix multiplications, inverse matrix multiplications, etc. as stored procedures that may be called by software.

A meta data module 250 may generate quantum safe encryption keys that may allow data to be encrypted (e.g., for later processing). A tokenize structure data module 252 may generate tokens for computational purposes from structured data (e.g., database data). A parsing unstructured data module 254 may parse unstructured data (e.g., random social media feeds in a data lake). Further, the parsing unstructured data module 254 may enable parsed words to be tokenized for computational purposes. A command conversion module 256 may convert commands into low-level computations. For example, the command conversion module 256 may convert API or client commands into actual computational commands (e.g., matrix multiplication). In some cases, the noise budget may need to be increased, the command conversion module 256 may convert the command into bootstrapping for lower-level computations. An audit/logging module 258 may provide a view of what API or client commands are received and executed.

An outcome analytics module 260 may provide inferences performed over FHE data. In some cases, the outcome analytics module may provide the FHE data in encrypted form before the FHE data is provided to outside modules/devices. For example, these outside modules/devices may include business intelligence tools 270, AI/ML tools 272, specific devices 274, or Internet of Things (IOT) devices 276, which may receive the FHE data via APIs. In another example, these outside modules/devices may include the proxy/agent form factor module 230, the virtual machine form factor module 232, or the middleware form factor module 234, which may receive the FHE data via form factors.

As illustrated, the API 210 may communicate with the business intelligence tools 270, the AI/ML tools 272, the specific devices 274, or the IOT devices 276. In generally, the business intelligence tools 270, the AI/ML tools 272, the user devices 274, and the IOT devices 276 represent examples of third party solutions providers that may integrate APIs of the systems, the methods, the computer-readable media, and the techniques disclosed herein to provide FHE capability in solutions to their clients.

The architecture for FHE capability within trusted AI solutions can be utilized by to or integrated to any third-party systems or components. As illustrated in FIG. 2, the trusted AI system 200 may be coupled to one or more of the third-party components 270-276 which may comprise third party solutions such as: Salesforce® (which may be embodied, e.g., in the business intelligence 270); AI tools such as a CNNs for image recognition (which may be embodied, e.g., in the AI/ML tools 272); secure communication devices, autonomous drones, MRI machines, etc. (one or more of which may be embodied, e.g., in the specific devices 274); or Internet connected devices such as camera (which may be embodied, e.g., in the IOT devices 276). In some cases, these third party solutions of elements 270-276 may be configured to provide analysis over encrypted data. In some cases, these third party solutions of elements 270-276 may license an API corresponding to the systems, the methods, the computer-readable media, and the techniques disclosed herein. In some cases, these third party solutions of elements 270-276 may embed FHE capabilities disclosed herein into their solutions, and thus, be able to provide analysis over encrypted data.

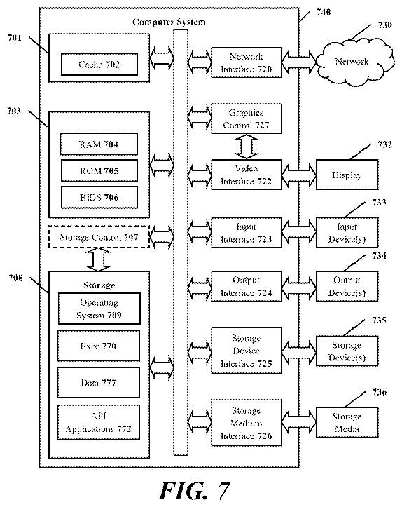

Referring to FIG. 7, a block diagram is shown depicting an example machine that includes a computer system 700 (e.g., a processing or computing system) within which a set of instructions can execute for causing a device to perform or execute any one or more of the methods or techniques for static code scheduling of the present disclosure. In some cases, one or more components of FIG. 2 may be included in or may be implemented by one or more components of the computer system 700. The components in FIG. 7 are examples and do not limit the scope of use or functionality of any hardware, software, embedded logic component, or a combination of two or more such components with particular implementations.

Computer system 700 may include one or more processors 701, a memory 703, and a storage 708 that communicate with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various tangible storage media 736. All of these elements may interface directly or via one or more interfaces or adaptors to the bus 740. For instance, the various tangible storage media 736 can interface with the bus 740 via storage medium interface 726. Computer system 700 may have any suitable physical form, including but not limited to one or more integrated circuits (Ics), printed circuit boards (PCBs), mobile handheld devices (such as mobile telephones or PDAs), laptop or notebook computers, distributed computer systems, computing grids, or servers.

Computer system 700 includes one or more processors 707 (e.g., central processing units (CPUs), general purpose graphics processing units (GPGPUs), or quantum processing units (QPUs)) that carry out functions. Processors 701 optionally contains a cache memory unit 702 for temporary local storage of instructions, data, or computer addresses. Processors 701 are configured to assist in execution of computer readable instructions. Computer system 700 may provide functionality for the components depicted in FIG. 7 as a result of the processors 701 executing non-transitory, processor-executable instructions embodied in one or more tangible computer-readable storage media, such as memory 703, storage 708, storage devices 735, or storage medium 736. The computer-readable media may store software that implements particular operations, and processors 701 may execute the software. Memory 703 may read the software from one or more other computer-readable media (such as mass storage devices 735, 736) or from one or more other sources through a suitable interface, such as network interface 720. The software may cause processors 701 to carry out one or more processes or one or more operations of one or more processes described or illustrated herein. Carrying out such processes or operations may include defining data structures stored in memory 703 and modifying the data structures as directed by the software.

The memory 703 may include various components (e.g., machine readable media) including, but not limited to, a random access memory component (e.g., RAM 704) (e.g., static RAM (SRAM), dynamic RAM (DRAM), ferroelectric random access memory (FRAM), phase-change random access memory (PRAM), etc.), a read-only memory component (e.g., ROM 705), and any combinations thereof. ROM 705 may act to communicate data and instructions unidirectionally to processors 701, and RAM 704 may act to communicate data and instructions bidirectionally with processors 701. ROM 705 and RAM 704 may include any suitable tangible computer-readable media described below. In one example, a basic input/output system 706 (BIOS), including basic routines that help to transfer information between elements within computer system 700, such as during start-up, may be stored in the memory 703.

Fixed storage 708 is connected bidirectionally to processors 701, optionally through storage control unit 707. Fixed storage 708 provides additional data storage capacity and may also include any suitable tangible computer-readable media FIG. Storage 708 may be used to store operating system 709, executables 710, data 711, applications 712 (application programs), and the like. Storage 708 can also include an optical disk drive, a solid-state memory device (e.g., flash-based systems), or a combination of any of the above. Information in storage 708 may, in appropriate cases, be incorporated as virtual memory in memory 703.

In one example, storage devices 735 may be removably interfaced with computer system 700 (e.g., via an external port connector (not shown)) via a storage device interface 725. Particularly, storage devices 735 and an associated machine-readable medium may provide non-volatile or volatile storage of machine-readable instructions, data structures, program modules, or other data for the computer system 700. In one example, software may reside, completely or partially, within a machine-readable medium on storage devices 735. In another example, software may reside, completely or partially, within processors 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands or other information into computer system 700 via input devices 733. Examples of an input devices 733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some cases, the input device is a Kinect, Leap Motion, or the like. Input devices 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In some cases, when computer system 700 is connected to network 730, computer system 700 may communicate with other devices, specifically mobile devices and enterprise systems, distributed computing systems, cloud storage systems, cloud computing systems, and the like, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processors 701 may access these communication packets stored in memory 703 for processing.

Examples of the network interface 720 include, but are not limited to, a network interface card, a modem, and any combination thereof. Examples of a network 730 or network segment 730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 730, may employ a wired or a wireless mode of communication. In general, any network topology may be used.

Information and data can be displayed through a display 732. Examples of a display 732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 732 can interface to the processors 701, memory 703, and fixed storage 708, as well as other devices, such as input devices 733, via the bus 740. The display 732 is linked to the bus 740 via a video interface 722, and transport of data between the display 732 and the bus 740 can be controlled via the graphics control 721. In some cases, the display is a video projector. In some cases, the display is a head-mounted display (HMD) such as a VR headset. In further cases, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further cases, the display is a combination of devices such as those disclosed herein.

In addition to a display 732, computer system 700 may include one or more other peripheral output devices 734 including, but not limited to, an audio speaker, a printer, a storage device, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more operations of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described above generally in terms of their functionality.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions FIG. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method, a technique, or an algorithm described in connection with the examples disclosed herein may be embodied directly in hardware, in a software module executed by one or more processors, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity may be suitable for use in the system FIG. Suitable tablet computers, in various cases, include those with booklet, slate, and convertible configurations.

In some cases, the computing device includes an operating system configured to perform executable instructions. The operating system is, for example, software, including programs and data, which manages the device's hardware and provides services for execution of applications. Suitable server operating systems may include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, UNIX®, and UNIX-like operating systems such as GNU/Linux®. In some cases, the operating system is provided by cloud computing. Suitable mobile smartphone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some cases, the systems, the methods, the computer-readable media, and the techniques the methods, the computer-readable media, and the techniques disclosed herein include one or more non-transitory computer readable storage media encoded with a program including instructions executable by the operating system of an optionally networked computing device. In further cases, a computer readable storage medium is a tangible component of a computing device. In still further cases, a computer readable storage medium is optionally removable from a computing device. In some cases, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

In some cases, the systems, the methods, the computer-readable media, and the techniques the methods, the computer-readable media, and the techniques disclosed herein include at least one computer program, or use of the same. A computer program includes a sequence of instructions, executable by one or more processors of the computing device's CPU, written to perform a specified task. Computer readable instructions may be implemented as program modules, such as functions, objects, APIs, computing data structures, and the like, that perform particular tasks or implement particular abstract data types. A computer program may be written in various versions of various languages.

The functionality of the computer readable instructions may be combined or distributed in various ways across various environments. In some cases, a computer program comprises one sequence of instructions. In some cases, a computer program comprises a plurality of sequences of instructions. In some cases, a computer program is provided from one location. In some cases, a computer program is provided from a plurality of locations. In some cases, a computer program includes one or more software modules. In some cases, a computer program includes, in part or in whole, one or more web applications, one or more mobile applications, one or more standalone applications, one or more web browser plug-ins, extensions, add-ins, or add-ons, or combinations thereof.

In some cases, a computer program includes a web application. A web application, in various cases, may utilize one or more software frameworks and one or more database systems. In some cases, a web application is created upon a software framework such as Microsoft® NET or Ruby on Rails (RoR). In some cases, a web application utilizes one or more database systems including, by way of non-limiting examples, relational, non-relational, object oriented, associative, XML, and document oriented database systems. In further cases, suitable relational database systems include, by way of non-limiting examples, Microsoft® SQL Server, mySQL™ and Oracle®. A web application, in some cases, may be written in one or more versions of one or more languages. A web application may be written in one or more markup languages, presentation definition languages, client-side scripting languages, server-side coding languages, database query languages, or combinations thereof. In some cases, a web application is written to some extent in a markup language such as Hypertext Markup Language (HTML), Extensible Hypertext Markup Language (XHTML), or extensible Markup Language (XML). In some cases, a web application is written to some extent in a presentation definition language such as Cascading Style Sheets (CSS). In some cases, a web application is written to some extent in a client-side scripting language such as Asynchronous Javascript and XML (AJAX), Flash ActionScript, JavaScript, or Silverlight®. In some cases, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some cases, a web application is written to some extent in a database query language such as Structured Query Language (SQL). In some cases, a web application integrates enterprise server products such as IBM® Lotus Domino®. In some cases, a web application includes a media player element. In some cases, a media player element utilizes one or more of many suitable multimedia technologies including, by way of non-limiting examples, Adobe® Flash®, HTML 5, Apple® QuickTime®, Microsoft® Silverlight®, Java™, and Unity®.

In some cases, a computer program includes a mobile application provided to a mobile computing device. In some cases, the mobile application is provided to a mobile computing device at the time it is manufactured. In other cases, the mobile application is provided to a mobile computing device via the computer network disclosed herein.

In view of the disclosure provided herein, a mobile application may be created using hardware, languages, and development environments known to the art. In some cases, mobile applications are written in several languages. Suitable programming languages may include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums may be available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, and Samsung® Apps.

In some cases, a computer program includes a standalone application, which is a program that is run as an independent computer process, not an add-on to an existing process, e.g., not a plug-in. Standalone applications may be compiled. A compiler may be a computer programs that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some cases, a computer program includes one or more executable complied applications.

In some cases, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Web browser plug-ins may include Adobe® Flash® Player, Microsoft® Silverlight®, and Apple® QuickTime®. In some cases, the toolbar comprises one or more web browser extensions, add-ins, or add-ons. In some cases, the toolbar comprises one or more explorer bars, tool bands, or desk bands.

Several plug-in frameworks may be available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some cases, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

In some cases, the systems, the methods, the computer-readable media, and the techniques disclosed herein include software, server, or database modules, or use of the same. Software modules may be created by techniques using machines, software, and languages. The software modules disclosed herein are implemented in a multitude of ways. In some cases, a software module comprises a file, a section of code, a programming object, a programming structure, a distributed computing resource, a cloud computing resource, or combinations thereof. In some cases, a software module comprises a plurality of files, a plurality of sections of code, a plurality of programming objects, a plurality of programming structures, a plurality of distributed computing resources, a plurality of cloud computing resources, or combinations thereof. In some cases, the one or more software modules comprise, by way of non-limiting examples, a web application, a mobile application, a standalone application, and a distributed or cloud computing application. In some cases, software modules are in one computer program or application. In some cases, software modules are in more than one computer program or application. In some cases, software modules are hosted on one machine. In some cases, software modules are hosted on more than one machine. In some cases, software modules are hosted on a distributed computing platform such as a cloud computing platform. In some cases, software modules are hosted on one or more machines in one location. In some cases, software modules are hosted on one or more machines in more than one location.

In some cases, the systems, the methods, the computer-readable media, and the techniques disclosed herein include one or more databases, or use of the same. In some cases, various databases may be suitable for storage and retrieval of various types of data (e.g., encrypted, unencrypted, etc.) one or more of which may be historical, present, or future data or information. In some cases, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some cases, a database is Internet-based. In further cases, a database is web-based. In still further cases, a database is cloud computing-based. In a particular case, a database is a distributed database. In other cases, a database is based on one or more local computer storage devices.

While preferred embodiments of the present invention have been shown and disclosed herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention disclosed herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

It should be noted that various illustrative or suggested ranges set forth herein are specific to their example embodiments and are not intended to limit the scope or range of disclosed technologies, but, again, merely provide example ranges for frequency, amplitudes, FIG. associated with their respective embodiments or use cases. Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

It should be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based at least in part on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are disclosed herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as disclosed herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, hardware modules may encompass a tangible entity, be that an entity that is physically constructed, permanently configured (e.g., hardwired), or temporarily configured (e.g., programmed) to operate in a certain manner or to perform certain operations disclosed herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information). Elements that are described as being coupled and or connected may refer to two or more elements that may be (e.g., direct physical contact) or may not be (e.g., electrically connected, communicatively coupled, etc.) in direct contact with each other, but yet still cooperate or interact with each other.

The various operations of example methods disclosed herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines disclosed herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It will be understood that, although the terms first, second, FIG. may be used herein to describe various elements, these elements should not be limited by these terms. These terms are only used to distinguish one element from another. For example, a first element may be termed a second element, and, similarly, a second element may be termed a first element, without departing from the scope of the present disclosure.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

1-68. (canceled)

69. An Application Programming Interface (API) for Universal Steganographic Watermarking, comprising:
(a) a conceal API configured to embed a secret data within a cover file and generate a sealed file;
(b) a reveal API configured to take the sealed file as input and extract the secret data; and
(c) a verify API configured to verify an integrity of the sealed file without extracting the secret data.

70. The API of claim 69, wherein the conceal API is further configured to perform operations comprising:
a) scrambling the secret data using a private seed value to generate scrambled secret data;
b) compressing the scrambled secret data into compressed secret data; and
c) hashing the compressed secret data to generate a cryptographic signature.

71. The API of claim 70, wherein the cryptographic signature is embedded into the cover file at an offset.

72. The API of claim 70, wherein a type of the cover file is selected from the group comprising a text file, an image file, a video file, an audio file, and an HTML file.

73. The API of claim 70, wherein the cryptographic signature is used by the verify API for verifying the integrity of the sealed file.

74. The API of claim 70, wherein the cryptographic signature is stored on a blockchain.

75. The API of claim 70, wherein the conceal API is further configured to, prior to scrambling the secret data, encode the cover file using an encoding scheme.

76. The API of claim 75, wherein the encoding scheme is selected based at least in part on a type of the cover file.

77. The API of claim 75, wherein the conceal API is further configured to, prior to scrambling the secret data, encode the secret data using an encoding scheme to produce encoded secret data.

78. The API of claim 77, wherein the conceal API is further configured to standardize the encoded secret data.

79. A method comprising:
implementing a provenance verification operation via steganographic watermarking, including:
concealing secret data within a cover file to generate a sealed file that is tamper-evident;
extracting the secret data from the sealed file;
evaluating the secret data to verify an integrity of the sealed file; and
verifying a provenance of the cover file based on the sealed file.

80. The method of claim 79 further comprising:
scrambling the secret data using a private seed value to generate scrambled secret data;
compressing the scrambled secret data to generate compressed secret data; and
hashing the compressing secret data to generate a cryptographic signature.

81. The method of claim 80 further comprising:
the secret data includes provenance data indicating a source of the cover file;
registering the sealed file and provenance data to a blockchain; and
verifying the provenance of the cover file by comparing secret data from the sealed file to the provenance data in the blockchain.

82. The method of claim 81 further comprising:
recording transactions relating to the sealed file to the blockchain; and
ensuring integrity of a supply chain based on transactions recorded to the blockchain.

83. The method of claim 80 further comprising:
adding the cryptographic signature to the secret data; and
embedding the compressed secret data and the cryptographic signature into the cover file to generate the sealed file.

84. The method of claim 83 further comprising:
verifying the integrity of the sealed file, further including:
extracting the cryptographic signature and the compressed secret data from the sealed file;
hashing the compressed secret data using a same cryptographic hash function used to generate the cryptographic signature to produce a comparison signature;
comparing the comparison signature to the cryptographic signature; and
determining that the sealed file has not been tampered with if the comparison signature matches the cryptographic signature.

85. The method of claim 84 further comprising:
verifying the integrity of the sealed file without unscrambling the scrambled secret data.

86. The method of claim 80 further comprising:
unscrambling the scrambled secret data using the private seed value after extracting the secret data.

87. The method of claim 84 further comprising:
encoding the secret data prior to scrambling with an encoding scheme; and
decoding the secret data using an inverse of the encoding scheme after unscrambling the secret data.

88. The method of claim 80 further comprising:
adaptively selecting from a plurality of hashing algorithms based on a type of the cover file.
